(19) United States
(12) Patent Application Publication
(10) Pub. No.: US 2012/0246269 A1
(43) Pub. Date: Sep. 27, 2012

(54) DATA PROCESSING APPARATUS, DATA PROCESSING METHOD, AND COMPUTER PROGRAM PRODUCT

(75) Inventors: Takeshi ISHIHARA, Kanagawa (JP); Yoshimichi Tanizawa, Kanagawa (JP); Kotaro Ise, Kanagawa (JP)

(73) Assignee: KABUSHIKI KAISHA TOSHIBA, Tokyo (JP)

(21) Appl. No.: 13/428,307

(22) Filed: Mar. 23, 2012

(30) Foreign Application Priority Data
Mar. 25, 2011 (JP) 2011-068927

(51) Int. Cl. G06F 15/16

(52) U.S. Cl. 709/217

(57) ABSTRACT

According to an embodiment, a data processing apparatus includes an acquiring unit configured to acquire structural information indicating a structure of data; a download control unit configured to download one or more partial data pieces among a plurality of partial data pieces obtained by separating the data on the basis of the structural information, using a separation position of the data as a download start position; a selection receiving unit configured to receive a selection of the separation position of the data; and an output unit configured to output the data from the selected separation position received by the selection receiving unit.

### CROSS-REFERENCE TO RELATED APPLICATION(S)

This application is based upon and claims the benefit of priority from Japanese Patent Application No. 2011-068927, filed on Mar. 25, 2011; the entire contents of which are incorporated herein by reference.

### FIELD

Embodiments described herein relate generally to a data processing apparatus, a data processing method, and a computer program product.

### BACKGROUND

A technique has been widely spread in which content is downloaded through a network and played. For example, there is a content distribution service that distributes content through a wide area network, such as the Internet, or a content sharing technique through a home network that shares content, such as movies and music, through a home network. In addition to the above-mentioned content distribution service, when content is distributed through a network, generally, a predetermined amount of the content is received and played (at the time when the content can be played) before the download of the content is completed. In this structure, the download process and the playing process temporally overlap each other to thereby hide the true download time from the user.

In recent years, various content download methods have been proposed. For example, the following download methods have been proposed: a method of downloading a plurality of content files in parallel; and a method of mechanically dividing one content file into a plurality of data pieces with the same size and downloading the data pieces.

In the related art, when a playing position is changed in content while the user is viewing the content and data is buffered at the changed playing position, there is no problem in viewing the content. However, when data has not been downloaded at the changed playing position, it is necessary to buffer the data. As a result, the playing of the content is likely to be stopped.

### BRIEF DESCRIPTION OF THE DRAWINGS

FIG. 1 is a diagram illustrating the structure of a communication device according to a first embodiment;

FIG. 2 is a diagram schematically illustrating a network to which the communication device according to the first embodiment is connected;

FIG. 3 is a diagram illustrating the structure of a content file specified by meta information according to the first embodiment;

FIG. 4 is a diagram illustrating a content download process of the communication device according to the first embodiment;

FIG. 5 is a diagram illustrating the download of content in the related art;

FIG. 6 is a sequence diagram illustrating the operation of the communication device according to the first embodiment;

FIG. 7 is a flowchart illustrating a process up to the start of the playing of content in the communication device according to the first embodiment;

FIG. 8 is a flowchart illustrating a process during the playing of content in the communication device according to the first embodiment;

FIG. 9 is a first sequence diagram illustrating the operation of components of the communication device according to the first embodiment when the process shown in FIG. 8 is performed;

FIG. 10 is a second sequence diagram illustrating the operation of the components of the communication device according to the first embodiment when the process shown in FIG. 8 is performed;

FIG. 11 is a first sequence diagram illustrating a process when a control unit of the communication device according to the first embodiment detects the generation of an event “operation of the user to move to Dₓ₁”;

FIG. 12 is a second sequence diagram illustrating the process when the control unit of the communication device according to the first embodiment detects the generation of the event “operation of the user to move to Dₓ₁”;

FIG. 13 is a diagram illustrating a first example of state information managed by a storage unit of the communication device according to the first embodiment;

FIG. 14 is a diagram illustrating a second example of the state information managed by the storage unit of the communication device according to the first embodiment;

FIG. 15 is a diagram illustrating a third example of the state information managed by the storage unit of the communication device according to the first embodiment;

FIG. 16 is a diagram illustrating a fourth example of the state information managed by the storage unit of the communication device according to the first embodiment;

FIG. 17 is a diagram illustrating a fifth example of the state information managed by the storage unit of the communication device according to the first embodiment;

FIG. 18 is a diagram illustrating a sixth example of the state information managed by the storage unit of the communication device according to the first embodiment;

FIG. 19 is a block diagram illustrating the structure of a communication device according to a second embodiment;

FIG. 20 is a block diagram illustrating the structure of a communication device according to a third embodiment;

FIG. 21 is a diagram schematically illustrating a network according to the third embodiment;

FIG. 22 is a diagram illustrating the change timing of the state of a content management server between an operating state and a non-operating state depending on the content download conditions of the communication device according to the third embodiment;

FIG. 23 is a sequence diagram illustrating an operation between the content management server and the communication device according to the third embodiment;

FIG. 24 is a flowchart illustrating a process up to the start of playing in the communication device according to the third embodiment;

FIG. 25 is a flowchart illustrating a process of the communication device according to the third embodiment during playing;

FIG. 26 is a diagram illustrating a first example of information which is stored in a storage unit as the analysis result of server information by a control unit according to the third embodiment;

FIG. 27 is a diagram illustrating a second example of the information which is stored in the storage unit as the analysis result of the server information by the control unit according to the third embodiment; and

FIG. 28 is a diagram illustrating a change in each state depending on the server information shown in FIG. 27.

### DETAILED DESCRIPTION

According to an embodiment, a data processing apparatus includes an acquiring unit configured to acquire structural information indicating a structure of data; a download control unit configured to download one or more partial data pieces among a plurality of partial data pieces obtained by separating the data on the basis of the structural information, using a separation position of the data as a download start position; a selection receiving unit configured to receive a selection of the separation position of the data; and an output unit configured to output the data from the selected separation position received by the selection receiving unit.

Various embodiments will be described hereinafter with reference to the accompanying drawings.

### First Embodiment

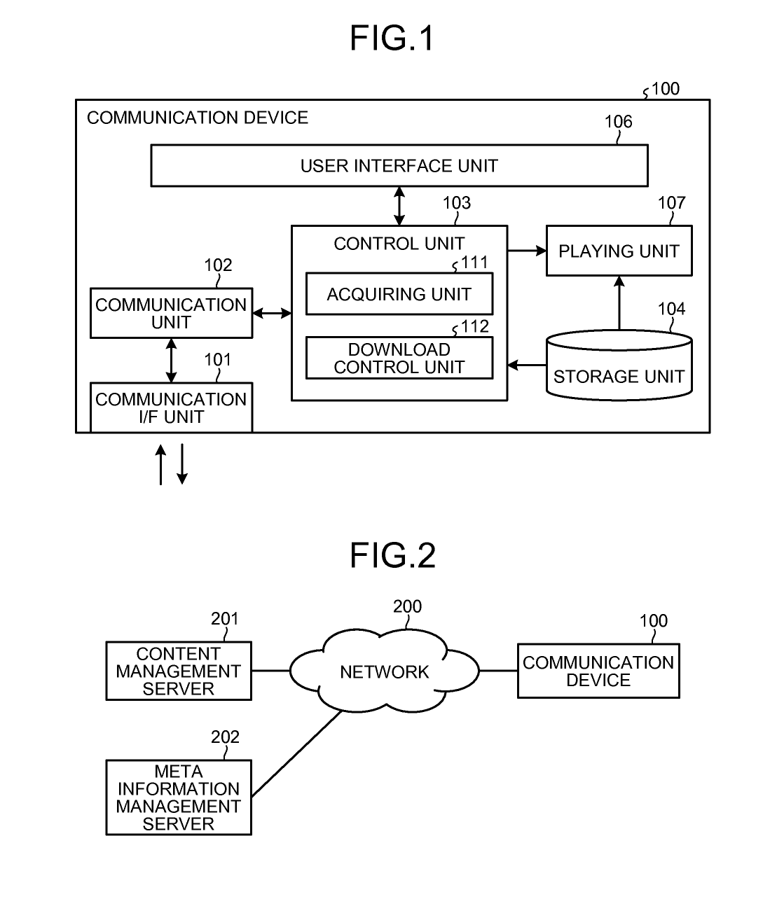

FIG. 1 is a diagram illustrating the structure of a communication device according to a first embodiment. As shown in FIG. 1, a communication device 100 includes a communication I/F unit 101, a communication unit 102, a control unit 103, a storage unit 104, a user interface unit 106, and a playing unit 107.

The communication I/F unit 101 is connected to a network by various methods, such as a wired LAN and a wireless LAN. The communication device 100 includes the communication I/F unit 101 to be thereby connected to the network.

FIG. 2 is a diagram schematically illustrating the network to which the communication device 100 is connected. As shown in FIG. 2, the communication device 100 is connected to a content management server 201 and a meta information management server 202 through a network 200.

The content management server 201 manages content.

The meta information management server 202 manages meta information indicating content or the structure of content. In this embodiment, the content management server 201 managing content and the meta information management server 202 are separately provided. Alternatively, one server may be provided for managing both content and meta information.

In this embodiment, the meta information is used as structural information for recognizing content or the structure of content. However, the structural information is not limited to the meta information. For example, the structure of the content may be included at the head of content data.

The meta information includes information indicating the structure of content. For example, the meta information includes the data size of the entire content or content playing time as information. The content is divided into a plurality of chapters (sections), and the start position (that is, content separation position) of each chapter is included in the meta information. Specifically, in the meta information, for example, as the content separation position, the start time or start byte of each chapter is associated with each corresponding chapter. As such, the meta information includes the information of a separation position which is likely to be used as a movement destination when playing point is moved to another scene during the viewing of the content.

That is, when an input to select the separation position is received from the user and content starts to be played from the separation position, the communication device 100 according to this embodiment increases the possibility of the user's desired content being played. The separation position is not limited to the separation position of the chapter. For example, the separation position may be the start or end position of a commercial message (CM).

In addition, the separation position set by a user other than the communication device 100 may be used. For example, a technique has been proposed in which a separation position of the content being uploaded is set by a user in order to view a recommended scene. In the technique, the meta information management server 202 acquires the separation position set by the user in order to view the recommended scene and stores the acquired separation position in the meta information. Then, the meta information management server 202 transmits the meta information to the communication device 100. In this way, a user can view content using the meta information including the separation position set by another user.

The meta information includes the bit rate of content. In the case of a constant bit rate (CBR), one bit rate is included in one content. In the case of a variable bit rate (VBR), an average bit rate is included in each of the sections of content.

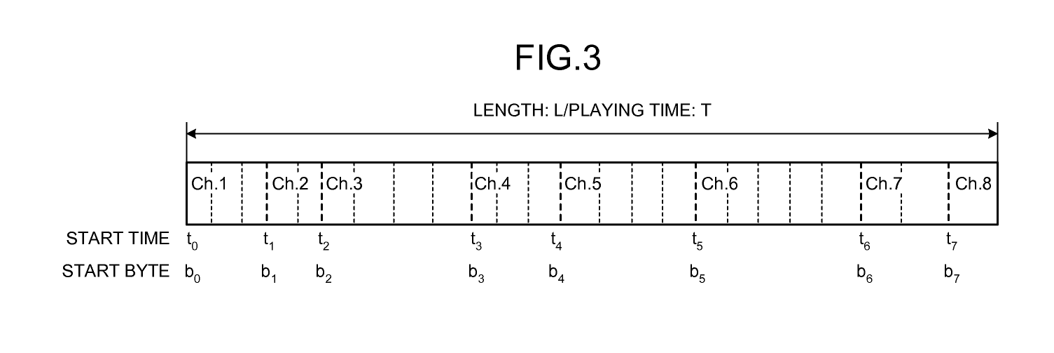

FIG. 3 is a diagram illustrating the structure of a content file specified by the meta information. In the example shown in FIG. 3, a content file with a length L and a playing time T is divided into eight sections. Each section is specified by a start time tᵢ (i=0, . . . , 7) or a start byte address bᵢ (i=0, . . . , 7). The communication device 100 according to this embodiment recognizes each of the divided sections as a chapter. When receiving an operation to move the chapter to an arbitrary one from a user through the user interface unit 106, the communication device 100 plays the content from the start time or start byte address corresponding to the chapter.

Each of the sections of the content includes further divided small sections (regions partitioned by a thin dashed line). The communication device 100 downloads data of the small sections from the content management server 201.

The data size of the small section is determined by a predetermined rule. That is, the data size of the small section is determined such that, when the user selects a section as a play target, the seamless playing is enabled by acquiring, before production of the data of a small section ends, the data of a subsequent small section from the content management server 201. The data size of the small section may be determined by the content management server 201 or the communication device 100. When the data size of the small section is determined by the content management server 201, a fixed data size satisfying the above-mentioned rule may be set. When the data size of the small section is determined by the communication device 100, it is determined so as to satisfy the above-mentioned conditions, considering the network speed between the content management server 201 and the communication device 100 and the bit rate of content.

Returning to FIG. 1, the communication unit 102 performs a process determined by a communication protocol, for example, TCP/IP to transmit or receive data to or from the content management server 201 or the meta information management server 202 connected to the network 200 through the communication I/F unit 101.

The storage unit 104 is, for example, a RAM or a hard disk and stores therein the content acquired from the content management server 201 or the meta information acquired from the meta information management server 202.

The control unit 103 includes an acquiring unit 111 and a download control unit 112 and controls the overall operation of the communication device 100. For example, the control unit 103 controls the playing unit 107 such that the acquired content is played, performs a process corresponding to a request input from the user through the user interface unit 106, or manages the buffer state of content using the storage unit 104.

The acquiring unit 111 controls the communication unit 102 such that meta information is acquired. The acquired meta information is stored in the storage unit 104. The meta information is analyzed to specify a plurality of divided sections of the content.

The download control unit 112 downloads the data of three sections in parallel among the plurality of divided chapters (sections) of the content which is specified on the basis of the meta information, using the separation positions between the chapters as download start positions.

In this embodiment, the number of chapters that can be downloaded in parallel is three, but the number of chapters that can be downloaded in parallel is not limited to three. The number of chapters that can be downloaded in parallel may be two or four or more. As such, the number of chapters that can be downloaded in parallel is a matter of design and may increase or decrease, if necessary. In order to effectively achieve the object of this embodiment, it is preferable that the number of chapters that can be downloaded in parallel be two or more. The parallel download may be performed by establishing a plurality of TCP connections, or may be performed by multiplexing data of chapters in one connection. Even when the chapters are downloaded one by one, any method may be used as long as a sufficient difference can be ensured between the download speed and the play speed. Next, an example of a downloading control process will be described.

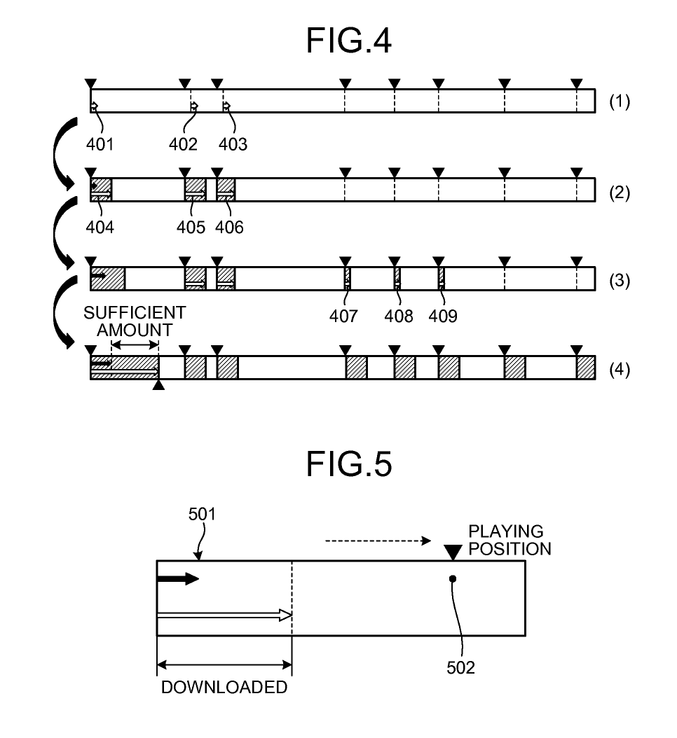

FIG. 4 is a diagram illustrating a content downloading process. The state (1) of FIG. 4 shows a state before content is downloaded. As described above, the content includes 8 chapters (sections). The download control unit 112 downloads the first to third chapters among the chapters in parallel from the start positions (start positions 401, 402, and 403) of the chapters.

Then, as shown in the state (2) of FIG. 4, the download control unit 112 stops the download for three chapters (sections), the first to third, at the point when the download of small sections (small sections 404, 405, and 406) is completed. In this way, when the playing unit 107 starts the playing of the downloaded chapter and the download control unit 112 resumes the download of the small sections subsequent to the downloaded small section, it is possible to seamlessly play the chapters.

Then, as shown in the state (3) of FIG. 4, the playing unit 107 starts to play the first chapter and the download control unit 112 downloads the chapters subsequent to the downloaded chapters in parallel from the start positions (start positions 407, 408, and 409). Then, the download control unit 112 downloads the chapters in the same way as described above. As shown in the state (4) of FIG. 4, the download control unit 112 completes the download of the small sections in each chapter of the content. In this way, even when an operation to move to any chapter is received from the user, it is possible to seamlessly play the chapter without waiting for playing at the chapter, which is a movement destination.

FIG. 5 is a diagram illustrating the download of content in the related art. As shown in FIG. 5, in the related art, when content is downloaded, the download of the content is continued from the start position. Therefore, when the user changes the content playing position from a playing position 501 to a playing position 502, the playing of the content is stopped since data has not been downloaded from the playing position 502. In contrast, the communication device 100 according to this embodiment downloads the small sections in a plurality of chapters of the content in parallel from the start positions. Therefore, when receiving an operation to move to each chapter from the user, the communication device 100 can seamlessly play the content.

The user interface unit 106 is an interface of the user who operates the communication device 100. For example, the user interface unit 106 is used by the user to select the start positions of the chapters dividing the content which is being played by the playing unit 107.

The playing unit 107 plays the content stored in the storage unit 104. The playing unit 107 plays (outputs) data from the start position of the chapter which is selected through the user interface unit 106.

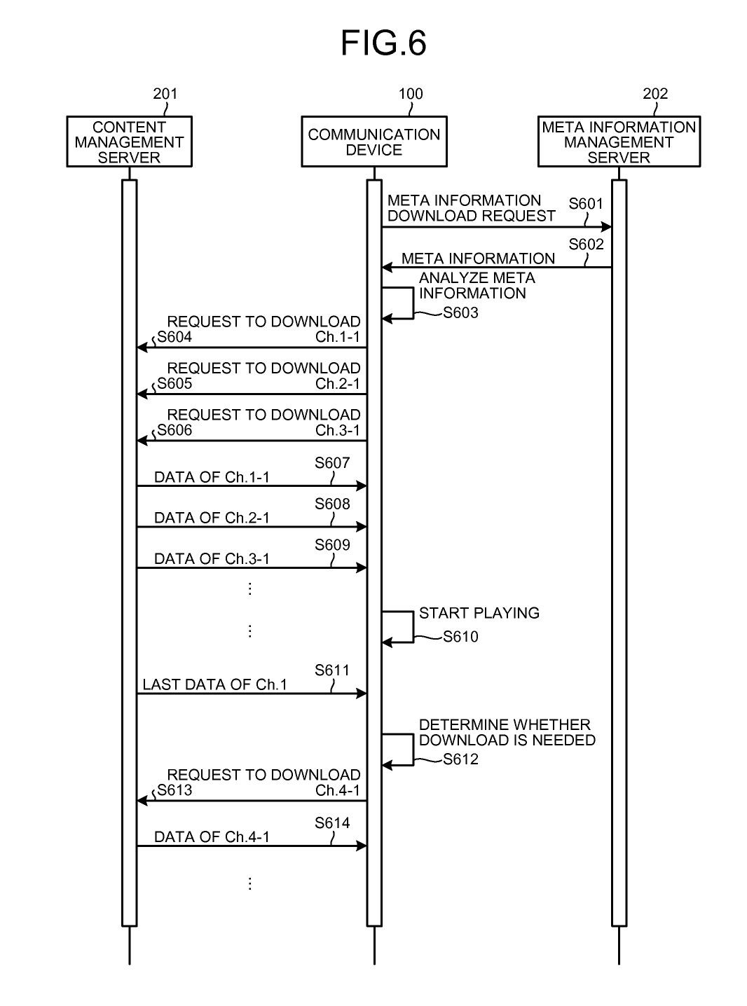

FIG. 6 is a sequence diagram illustrating the operation of the communication device 100. First, the communication device 100 acquires the meta information of content, which is a playing target. Any method may be used to acquire the meta information. In this embodiment, as described above, it is assumed that the meta information of content is prepared in the meta information management server 202 in advance.

First, the acquiring unit 111 of the communication device 100 transmits a request to download meta information to the meta information management server 202 through the communication unit 102 in order to acquire the meta information of the content (Step S601). The meta information management server 202 transmits meta information corresponding to the requested content in response to the request (Step S602).

Then, when the acquiring unit 111 of the communication device 100 acquires the meta information through the communication unit 102 and stores the acquired meta information in the storage unit 104, the control unit 103 analyzes the meta information and checks the structure of the content, which is a playing target (Step S603). In this way, it is possible to know the start position of each chapter in the content, which is a playing target.

Then, the download control unit 112 of the communication device 100 according to this embodiment requests the download of the content, which is a playing target. In this embodiment, as described above, it is assumed that the communication device 100 can download a maximum of three chapters in parallel. The download control unit 112 can download the maximum number of chapters (in this embodiment, three chapters) in parallel at the same time. Then, the download control unit 112 performs a step of requesting the download of a first small section (Ch.1-1) of chapter 1 (Ch.1) (Step S604), a step of requesting the download of a first small section (Ch.2-1) of chapter 2 (Ch.2) (Step S605), and a step of requesting the download of a first small section (Ch.3-1) of chapter 3 (Ch.3) (Step S606) in parallel.

Then, the download control unit 112 of the communication device 100 according to this embodiment sequentially downloads the chapters from the small section of the first chapter (section) of the file. That is, the download control unit 112 downloads the chapters from the data of the first small section of the section specified by b₀ bytes. Thereafter, the download control unit 112 downloads the other sections. In this way, the download control unit 112 downloads the data of the first small sections (Ch.1-1, Ch.2-1, and Ch.3-1) of three chapters, chapter 1 (Ch.1) to chapter 3 (Ch.3), in parallel (Steps S607 to S609).

When a sufficient amount of data to be played is downloaded for the first section (Ch.1), the playing unit 107 of the communication device 100 starts to sequentially play the content from the head (the start position of the first chapter) (Step S610).

When any one of small sections in the chapter that is being downloaded is completely downloaded over time, the control unit 103 of the communication device 100 determines whether there is a chapter (section), among the chapters (sections) of the content, whose first small section has not been downloaded.

In the example shown in FIG. 6, it is assumed that the download control unit 112 controls the download of the last data of the first small section of chapter (section) 1 (Ch.1) through the communication unit 102 and the download of the first small section of chapter (section) 1 (Ch.1) is completed (Step S611).

After the above-described download is completed, the control unit 103 determines whether there is a section that has not been downloaded (Step S612). In the example shown in FIG. 6, the control unit 103 detects that the download of the first small section of chapter (section) 4 (Ch.4) is not completed. During the playing of chapter (section) 1 (Ch.1), when a data size is too small to seamlessly play chapter 1, small sections subsequent to the first small section of the chapter 1 may be continuously downloaded.

Then, the download control unit 112 requests the download of the first small section (Ch. 4-1) of chapter 4 (Ch.4) (Step S613). The download control unit 112 downloads the first small section (Ch. 4-1) of chapter 4 (Ch.4) in parallel to the small sections of other chapters that have not been completely downloaded according to the request (Step S614).

When the control unit 103 determines that there is no section which has not been completely downloaded, the download control unit 112 sequentially downloads the small sections that have not been completely downloaded, among the small sections subsequent to the small section which is currently being played.

As such, the communication device 100 according to this embodiment preferentially acquires the data of the small section from the start position of a chapter, which is a movement destination, considering the structure of the content to be played. In this way, even when the user interface unit 106 receives, for example, an operation to move the chapter while the playing unit 107 plays content, it is possible to reduce the possibility of data being rebuffered, avoid the delay of data, and seamlessly play content.

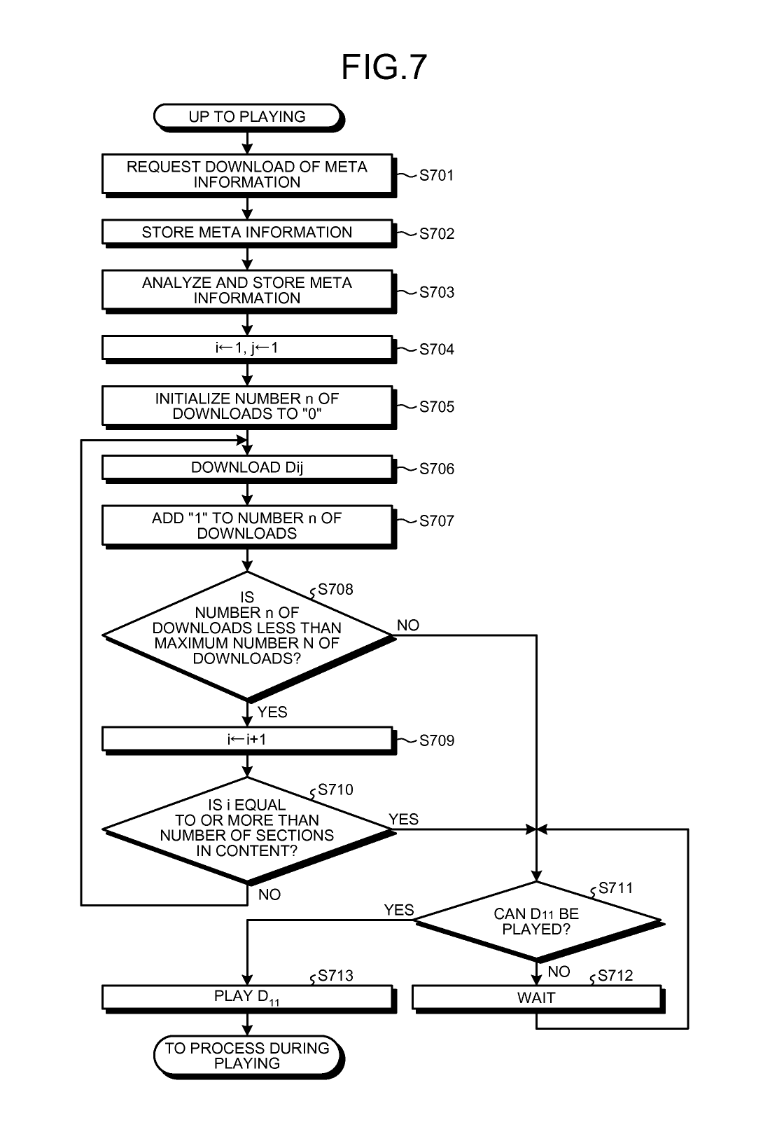

Next, the process of the communication device 100 up to playing will be described. FIG. 7 is a flowchart illustrating the process of the communication device 100 up to the playing of content. In the flowchart, a movie is represented by indexes i and j. It is assumed that an index is the index of a section and an index j is the index of a small section.

First, the acquiring unit 111 of the communication device 100 transmits a request to download the meta information of content to the meta information management server 202 through the communication unit 102 (Step S701). Then, the acquiring unit 111 stores the acquired meta information in the storage unit 104 (Step S702). Then, the control unit 103 analyzes the meta information and checks the structure of the content, which is a playing target (Step S703). Then, the control unit 103 initializes the indexes i and j of the content to “1” (Step S704). In addition, the control unit 103 initializes the value of a download counter (hereinafter, referred to as a download counter n) to “0” (Step S705).

Then, the download control unit 112 starts to download a small section Dij of each chapter of the content (Step S706).

When the download of the small section starts normally, the control unit 103 adds “1” to the download counter n (Step S707).

Then, the control unit 103 determines whether the download counter n is less than the maximum number N of downloads (upper limit: “3”) (Step S708). When it is determined that the download counter n is less than the maximum number N of downloads (Step S708: Yes), the control unit 103 adds “1” to the index i (Step S709). Then, the control unit 103 determines whether the index i is equal to or more than the number of sections in the content (Step S710). When it is determined that the index i is less than the number of sections (Step S710: No), the download control unit 112 starts to download the small section Dij of another chapter (Step S706). As such, Steps S706 to S710 are repeatedly performed to thereby download the small sections of a plurality of chapters in parallel.

When the download counter n is equal to or more than the maximum number N of downloads (Step S708: No) or when the index i is equal to or more than the number of sections in the content (Step S710: Yes), the control unit 103 determines whether a small section D₁₁ of chapter 1, which is the first chapter, of the content can be played (Step S711). When it is determined that the small section D₁₁ cannot be played (that is, when it is determined that the data size of the downloaded chapter is insufficient) (Step S711: No), the control unit 103 waits until the conditions are satisfied (Step S712). Then, the control unit 103 periodically determines whether the small section can be played.

When the control unit 103 determines that the small section can be played (Step S711: Yes), the playing unit 107 starts to play the small section D₁₁ of chapter 1 (Step S713). Then, the process proceeds to the next step.

The above is the process of the communication device 100 up to the start of playing. In the flowchart shown in FIG. 7, it is assumed that the download of the small sections has not been completed during a series of processes. However, if it is considered that the download of the small sections is completed, the process is the same as that during playing, which will be described below.

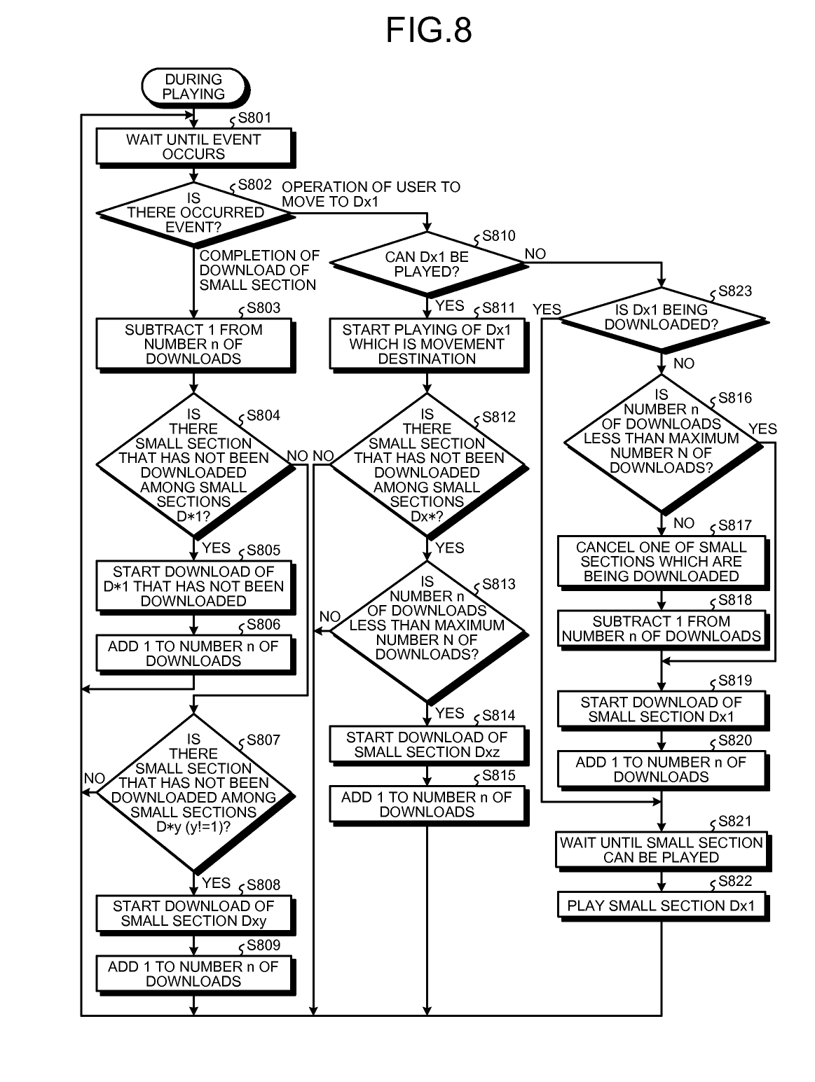

Next, the process of the communication device 100 during playing will be described. FIG. 8 is a flowchart illustrating the process of the communication device 100 during the playing of content.

In the communication device 100 according to this embodiment, the flow of the process during playing is event-driven. Therefore, the control unit 103 waits until an event occurs (Step S801). In the flowchart shown in FIG. 8, an unnecessary event is not described, but only the case in which an event “completion of the download of a small section” and an event “operation of the user to move to Dₓ₁” occur is described.

Then, the control unit 103 determines the occurred event (Step S802). When the control unit 103 determines that the event “completion of the download of a small section” occurs (Step S802: the lower side), it subtracts “1” from the download counter n (Step S803). Then, the control unit 103 determines whether there is a small section which has not been downloaded among the first small sections D_{*1} of other chapters (Step S804). When it is determined that there is a small section which has not been downloaded (Step S804: Yes), the download control unit 112 starts to download one of the small sections D_{*1} which have not been downloaded (Step S805). Then, the control unit 103 adds “1” to the download counter n (Step S806). When it is difficult to ensure a sufficient playing time only with the first small section downloaded by a client, the process may be changed such that two small sections from the head of the section may be continuously downloaded.

When it is determined that there is no small section which has not been downloaded among the first small sections D_{*1} of other chapters (Step S804: No), the control unit 103 determines whether there is a small section D_{*y} (y!=1) which has not been downloaded (Step S807). When it is determined that there is no small section D_{*y} (y!=1) which has not been downloaded (Step S807: No), the control unit 103 waits until an event occurs (Step S801). On the other hand, when it is determined that there is a small section D_{*y} (y!=1) which has not been downloaded (Step S807: Yes), the download control unit 112 starts to download at least one of the small sections D_{*y} (y!=1) (Step S808). The control unit 103 adds “1” to the download counter n (Step S809). In Step S808, the small sections are downloaded in the order such that the small section with earlier playing timing is downloaded earlier when the current playing is continuously performed.

Next, a process when the control unit 103 determines that the event “operation of the user to move to Dₓ₁” occurs in Step S802 (Step S802: the right side) will be described. This process depends on whether the data Dₓ₁ of the first small section in the section Dₓ, which is a movement destination, has been downloaded. That is, the control unit 103 determines whether the data Dₓ₁ of the small section can be played (Step S810).

When it is determined that the data Dₓ₁ of the small section can be played, that is, when the number of bytes of the downloaded data Dₓ₁ is equal to or more than a predetermined value that can be played (Step S810: Yes), the control unit 103 starts to play the data Dₓ₁ (Step S811). Then, the control unit 103 determines whether there is a small section that has not been downloaded among the other small sections D_{x*} in the same section as that including the data Dₓ₁ which starts to be played (Step S812). When it is determined that all of the small sections have been downloaded (Step S812: No), the control unit 103 waits until an event occurs (Step S801).

On the other hand, when it is determined that there is a small section that has not been downloaded among the small sections D_{x*}(Step S812: Yes), the control unit 103 determines whether the current download counter n is equal to or more than the maximum number N of downloads (Step S813).

When it is determined that the current download counter n is less than the maximum number N of downloads (Step S813: No), the control unit 103 waits until an event occurs (Step S801).

In addition, when it is determined that the current download counter n is less than the maximum number N of downloads (Step S813: No), the download control unit 112 starts to download the small sections D_{x*}(Step S814). Then, the control unit 103 adds “1” to the download counter n (Step S815).

When it is determined in Step S810 that the data Dₓ₁ of the small section cannot be played, that is, when it is determined that all of the data Dₓ₁ of the small sections is not downloaded or it does not satisfy the number of bytes which can be played (Step S810: No), the control unit 103 determines whether the data Dₓ₁ of the small section is being downloaded (Step S823). When it is determined that the data Dₓ₁ of the small section is not being downloaded (Step S823: No), the control unit 103 determines whether the download counter n is less than the maximum number N of downloads (Step S816). When it is determined that the download counter n is equal to or more than the maximum number N of downloads (Step S816: No), the control unit 103 cancels one of the small sections that are being downloaded (Step S817). Various rules for determining a target small section to be canceled may be used. For example, the following small sections are cancelled: the least downloaded small section; the latest small section that starts to be downloaded; a small section included in the section that antedates the section which is currently being played; and a small section that is furthest from the section that is currently being played in terms of time. Then, the control unit 103 subtracts “1” from the download counter n with the cancellation of the small section (Step S818).

After Step S818 or when it is determined that the download counter n is less than the maximum number N of downloads (Step S816: Yes), the download control unit 112 starts to download the data Dₓ₁ of the small section, which is a movement destination (Step S819). At that time, the control unit 103 adds “1” to the download counter n (Step S820). Then, the control unit 103 waits until the data Dₓ₁ of the small section can be played (Step S821). Then, when the data Dₓ₁ of the small section can be played, the playing unit 107 starts playing (Step S822) and the process returns to the origin (Steps S821 and Step S822).

When the data Dₓ₁ is currently being downloaded (Step S823: Yes), the control unit 103 waits until the data Dₓ₁ of the small section can be played (Step S821). When the data Dₓ₁ of the small section can be played, the control unit 103 starts playing (Step S822). Then, the control unit 103 waits until an event occurs (Step S801).

As such, the communication device 100 downloads a small section corresponding to the start portion of each chapter which is likely to be moved by the operation of the user in advance. In this way, when an operation to move the chapter is received from the user, it is possible to reduce the possibility of data being downloaded immediately after the moving operation. As a result, it is possible to hide a download delay from the user.

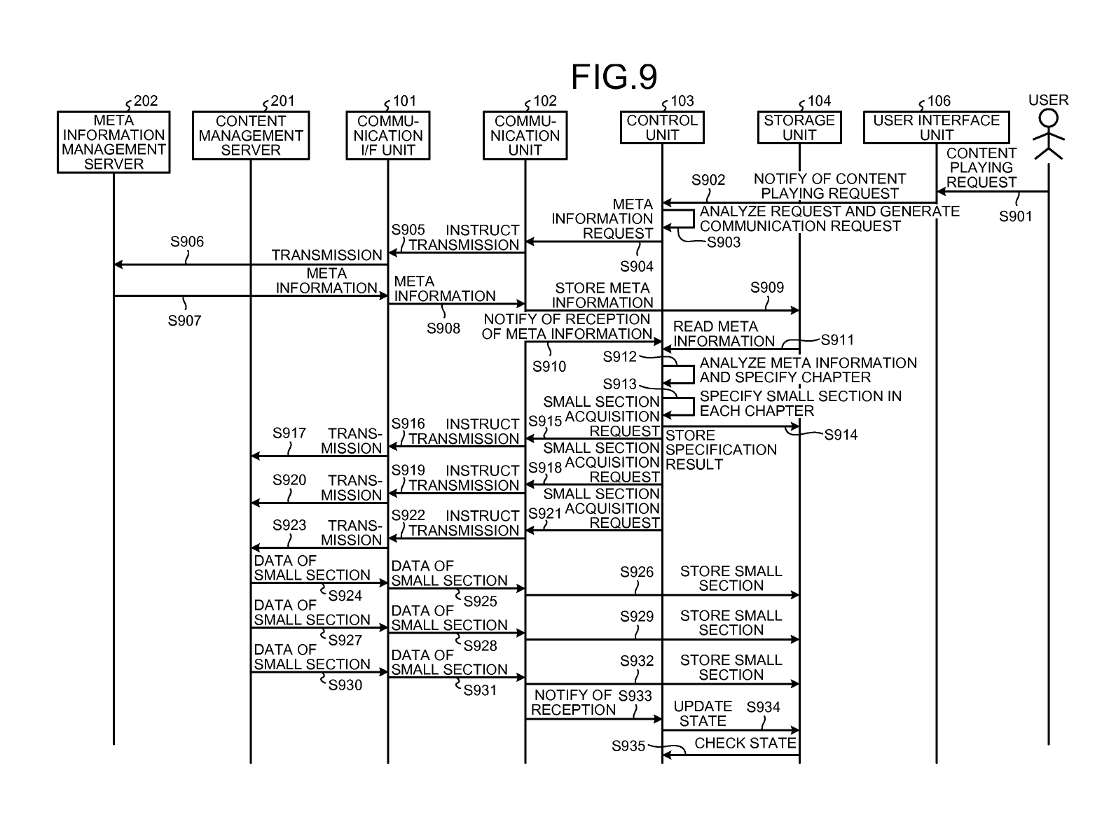

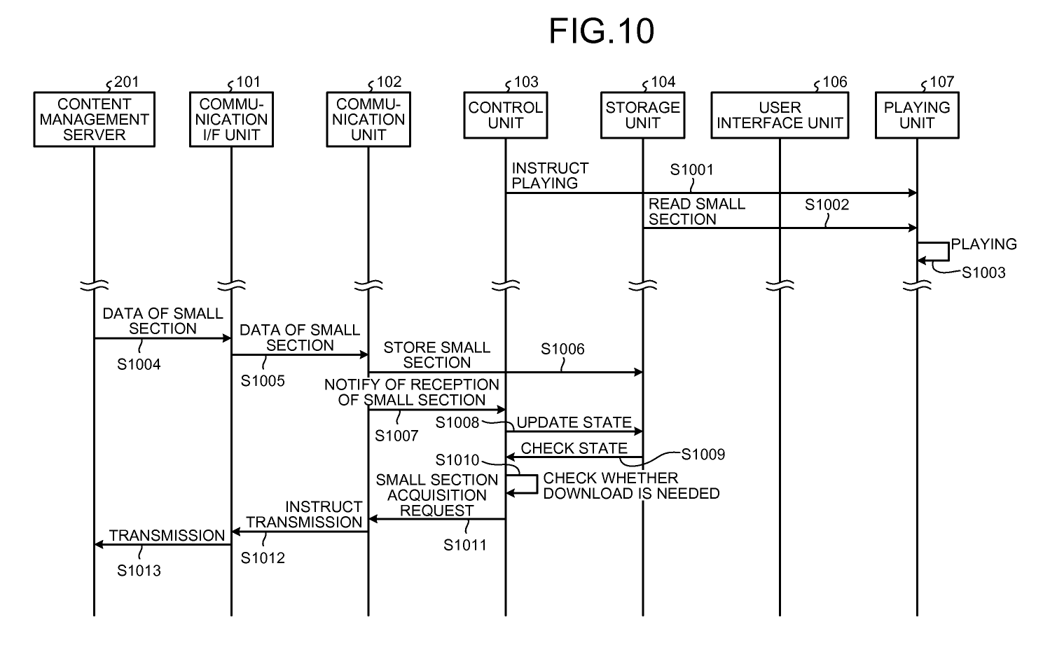

Next, the function and operation of each component of the communication device 100 according to this embodiment will be described in detail. FIGS. 9 and 10 are sequence diagrams illustrating the operation of each component when the communication device 100 performs the process shown in FIG. 8.

The user interface unit 106 receives a content playing request from the user (Step S901). Then, the user interface unit 106 notifies the control unit 103 that the playing request has been received (Step S902). Then, the acquiring unit 111 of the control unit 103 analyzes the content playing request and generates a request to acquire the content selected by the user and meta information corresponding to the content (Step S903). Then, the acquiring unit 111 outputs a meta information acquisition request to the communication unit 102 (Step S904).

In this way, the communication unit 102 transmits the meta information acquisition request to the content management server 201 through the communication I/F unit 101 (Steps S905 and S906).

When receiving the meta information acquisition request, the meta information management server 202 returns meta information to the communication device 100 (Step S907). Then, the communication unit 102 receives the meta information through the communication I/F unit 101 (Step S908) and stores the received meta information in the storage unit 104 under the control of the acquiring unit 111 (Step S909). Then, the communication unit 102 notifies the acquiring unit 111 of the control unit 103 that the meta information has been received (Step S910).

When the acquiring unit 111 of the control unit 103 receives the reception notice, it is determined that the meta information is appropriately acquired. Then, the control unit 103 reads the meta information stored in the storage unit 104 (Step S911). Then, the control unit 103 analyzes the meta information and specifies the start byte (separation position) of each chapter in the content (Step S912). As a result, the control unit 103 recognizes that the content has, for example, the structure shown in FIG. 3. The analysis result is stored in the storage unit 104. In addition, the control unit 103 specifies a small section, which is a download unit, in each chapter (Step S913). As described above, various methods are considered in order to specify the small section. The control unit 103 stores each chapter in the specified content and the specified small sections in each chapter as the specification result in the storage unit 104 (Step S914).

In this embodiment, it is possible to download three small sections in each chapter in parallel. Therefore, the download control unit 112 of the control unit 103 outputs a request to acquire the small sections of another chapter to the communication unit 102 three times (Steps S915, S918, and S921). Then, the communication unit 102 transmits the three acquisition requests to the content management server 201 through the communication I/F unit 101 (Steps S916, S917, S919, S920, S922, and S923). The control unit 103 appropriately increases or decreases the download counter n shown in FIG. 8 and a description thereof will not be repeated.

Then, the content management server 201 transmits the data of the three small sections to the communication device 100 in parallel (Steps S924, S927, and S930). Then, the communication unit 102 receives the data of the three small sections through the communication I/F unit 101 in parallel (Steps S924, S925, S927, S928, S930, and S931). Then, the communication unit 102 stores the data of the three small sections in the storage unit 104 in parallel under the control of the download control unit 112 (Steps S926, S929, and S932).

In addition, the communication unit 102 notifies the download control unit 112 of the control unit 103 that the data of the small sections has been received (Step S933). When receiving the notice, the control unit 103 updates and checks the download state of the content (Step S934 and S935). The subsequent steps will be described with reference to FIG. 10.

When the control unit 103 checks the download state of the content in Step S935 of FIG. 9 and determines that the small section in the first chapter of the content can be played, it instructs the playing unit 107 to play the content (Step S1001). The playing unit 107 reads the data of the small section from the storage unit 104 (Step S1002) and plays the data (Step S1003) in response to the instruction.

Next, a process when the data of a small section in another chapter is downloaded after the download of the data of a small section in a chapter ends will be described. First, similarly to the process (Steps S924 to S932) shown in FIG. 9, a process from the download of the data of a small section to the storage of the data is performed (Steps S1004 to S1006). Then, the communication unit 102 notifies that the data of the small section has been received (Step S1007). The download state of the content is updated (Step S1008) and the download state of the content is checked (Step S1009). The check step enables the control unit 103 to know whether all small sections are downloaded.

The control unit 103 determines whether there is the data of the small section to be downloaded (Step S1010). This determination corresponds to Step S804 or Step S807 of FIG. 8 and the determination rule varies depending on the situation.

When the control unit 103 determines that there is the data of the small section to be downloaded, the download control unit 112 transmits a request to acquire the data of the small section to the content management server 201 through the communication unit 102 and the communication I/F unit 101 (Steps S1011 to S1013). Then, the download of the data of the small section corresponding to the acquisition request from the content management server 201 starts.

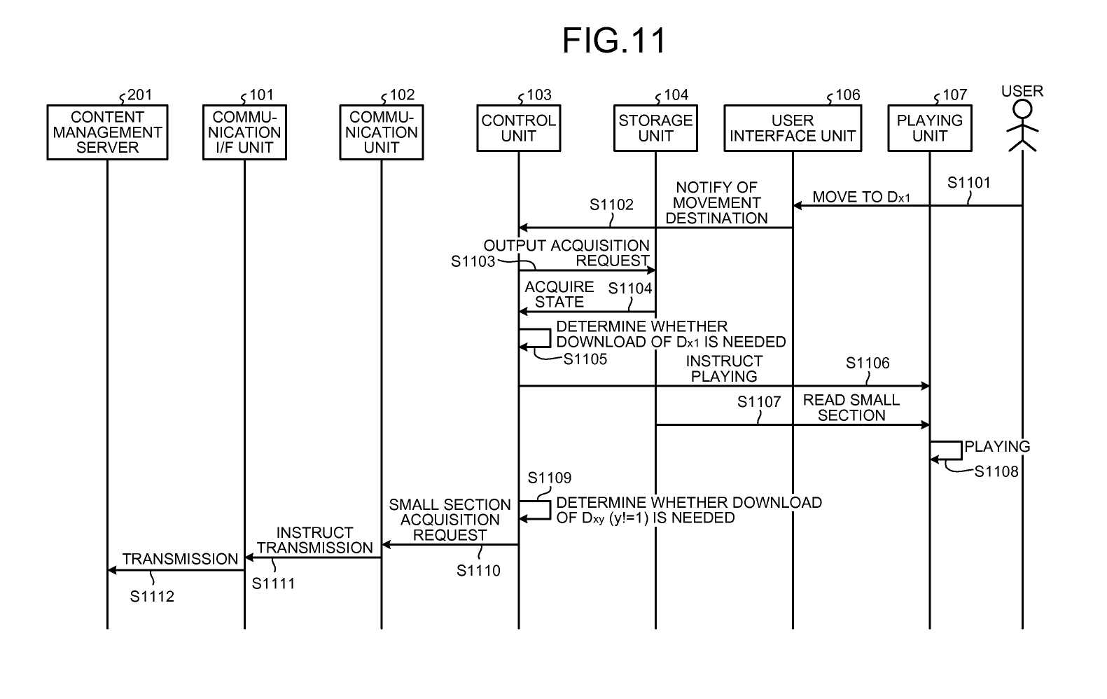

Next, a process when it is determined in Step S802 of FIG. 8 that the event “operation of the user to move to Dₓ₁” occurs (Step S802: the right side) will be described. FIG. 11 is a sequence diagram illustrating the process when the control unit 103 detects the occurrence of the event “operation of the user to move to Dₓ₁”.

First, the user interface unit 106 receives a user's selection to move to Dₓ₁ as a movement destination (Step S1101). Then, the user interface unit 106 notifies the control unit 103 of the selected movement destination (Step S1102). Then, the control unit 103 outputs an acquisition request to the storage unit 104 (Step S1103) and acquires the download state of the notified movement destination (Dₓ₁ in this process) from the storage unit 104 (Step S1104). Then, the control unit 103 determines whether download is needed in order to perform playing on the basis of the stored state information (Step S1105). In the sequence diagram, a case in which the control unit 103 determines that no download is needed (Step S810: Yes) in Step S810 of FIG. 8 will be described.

When it is determined that no download is needed, the control unit 103 outputs a playing instruction to the playing unit 107 (Step S1106). The playing unit 107 reads the data Dₓ₁ of the small section from the storage unit 104 (Step S1107) and starts the playing of the data Dₓ₁ of the small section (Step S1108). Then, the control unit 103 determines whether download is needed for the small sections D_{xy} (y!=1) in the section D_{X} (Step S1109). In this sequence diagram, a case in which the control unit 103 determines that download is needed will be described.

When the control unit 103 determines that download is needed, the communication unit 102 transmits a request to download the data of the small section to the content management server 201 under the control of the download control unit 112 of the control unit 103 (Steps S1110 to S1112).

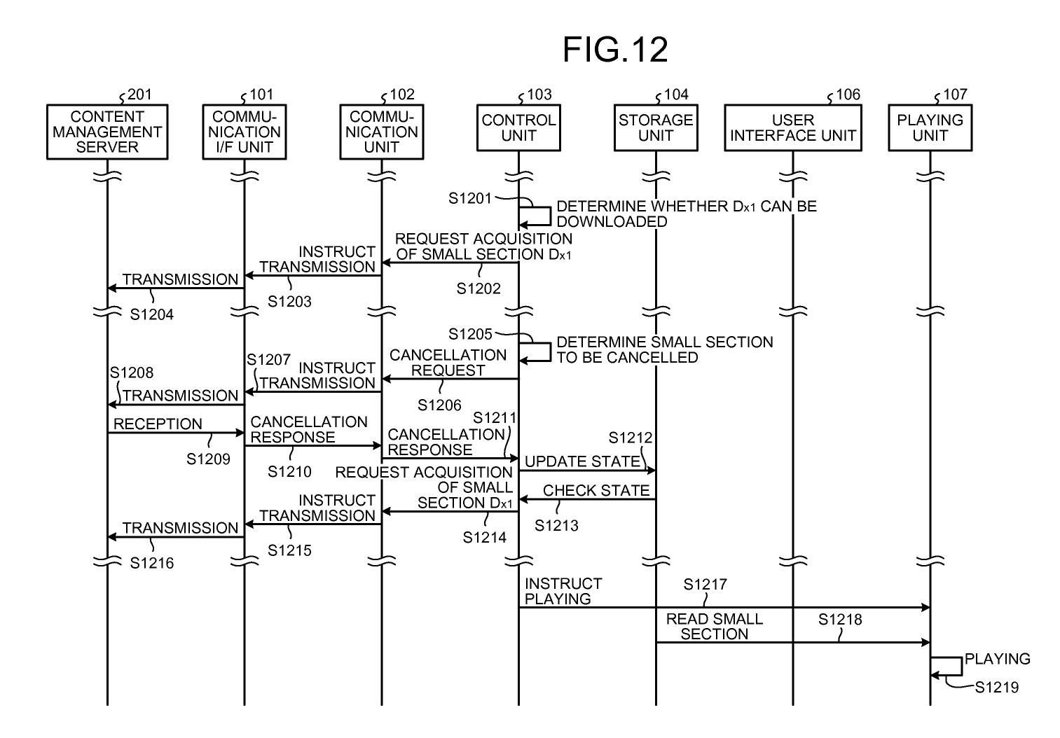

Subsequently, a process when the control unit 103 detects the occurrence of the event “operation of the user to move to Dₓ₁” will be described with reference to FIG. 12.

Next, a case in which the control unit 103 determines that Dₓ₁, which is a movement destination, needs to be downloaded in Step S810 of FIG. 8 (Step S810: No) will be described. It is assumed that Dₓ₁, which is a movement destination, has not been downloaded (Step S823: No). In this case, when the control unit 103 determines that Dₓ₁, which is a movement destination, needs to be downloaded, it is determines whether the download counter n is equal to or more than the maximum number N of downloads, that is, whether download can start immediately (Step S1201). This step corresponds to Step S816 of FIG. 8. In the process, it is assumed that download can start immediately.

When the control unit 103 determines that download can start immediately, the communication unit 102 transmits an acquisition request to the content management server 201 through the communication I/F unit 101 under the control of the download control unit 112 of the control unit 103 (Steps S1202 to S1204). In this way, the download of the data Dₓ₁ of the small section from the content management server 201 starts.

On the other hand, when the control unit 103 determines that download cannot start immediately in step S1201, it specifies the data of the small section which is being downloaded and is to be cancelled (Step S1205). Then, the communication unit 102 transmits a notice indicating the cancellation of the data of the specified small section to the content management server 201 through the communication I/F unit 101 under the control of the control unit 103 (Steps S1206 to S1208). The communication unit 102 receives a cancellation response from the content management server 201 through the communication I/F unit 101 (Steps S1209 and S1210) and notifies the received cancellation response to the control unit 103 (Step S1211).

Then, the control unit 103 updates the state information stored in the storage unit 104 in response to the cancellation response (Step S1212). Then, the control unit 103 checks the state information (Step S1213). The download of one small section is cancelled, and thus it is possible to download the data Dₓ₁ of the small section. Then, the communication unit 102 transmits a request to download the data Dₓ₁ of the small section to the content management server 201 under the control of the download control unit 112 of the control unit 103 (Steps S1214 to S1216). In this way, the download of the data Dₓ₁ of the small section from the content management server 201 starts.

When the control unit 103 determines that the amount of downloaded data Dₓ₁ of the small section is sufficient to be played after a predetermined period of time has elapsed, it outputs a playing instruction to the playing unit 107 (Step S1217). Then, the playing unit 107 reads the data Dₓ₁ of the small section from the storage unit 104 (Step S1218) and starts the playing of the data Dₓ₁ of the small section (Step S1219).

In the above description, in the communication device 100, when the playing of a small section ends, the playing of the next small section starts automatically. Similarly, in the communication device 100, when the playing of the last small section in the section that is being played ends, the playing of the next section starts automatically. In this case, the first small section of each section is very likely to be downloaded prior to playing. However, in some cases, the first small section of each section is not downloaded prior to playing. In this case, the same process as that when the event “operation of the user to move to Dₓ₁” occurs may be performed.

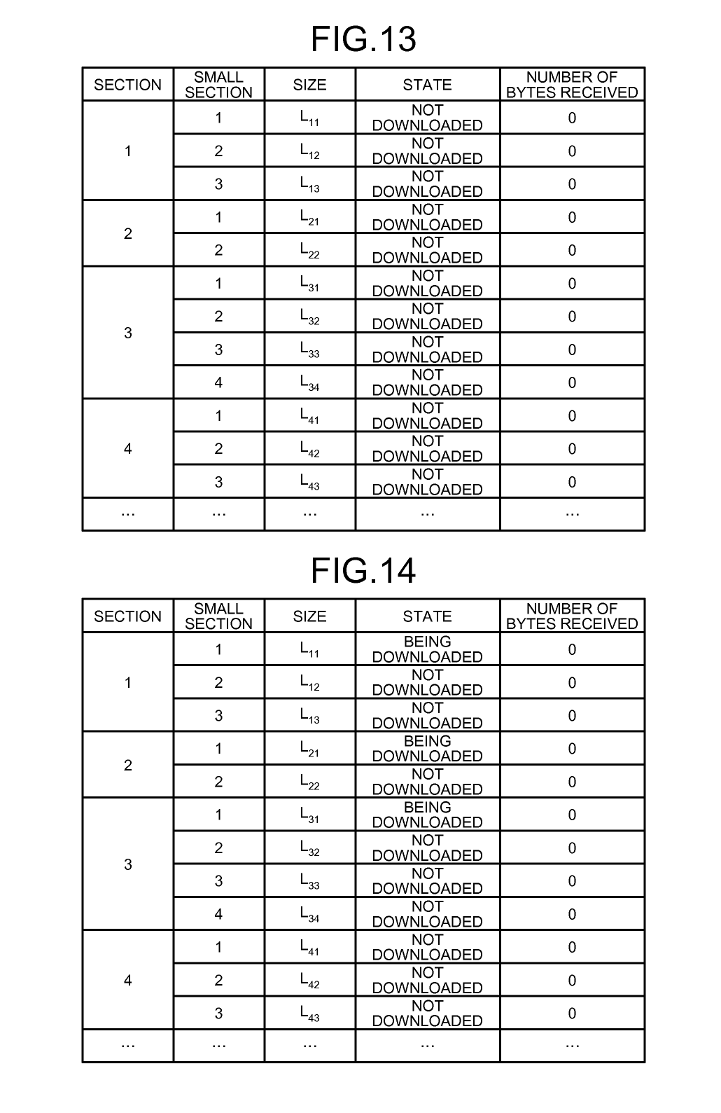

Next, various kinds of information stored in the storage unit 104 of the communication device 100 will be described. FIGS. 13 to 18 are diagrams illustrating an example of the state information managed by the storage unit 104. A content file having the structure shown in FIG. 3 is used as an example of the state information shown in FIGS. 13 to 18.

In FIGS. 13 to 18, the state information is represented in a table format having each small section as one entry. However, any format may be used as long as it can treat equivalent information. The state information is generated at the time when the control unit 103 ends the analysis of the meta information (Step S903 of FIG. 9) and is then stored in the storage unit 104.

As shown in Steps S915 to S923 of FIG. 9, when a request to acquire each small section is transmitted from the communication unit 102 under the control of the download control unit 112, the state shown in FIG. 14 is obtained (the update of the state information is not shown in FIG. 9 for simplicity). As such, the download of the data of the first small section in each of the first to third chapters starts.

Then, the control unit 103 updates a corresponding entry with the number of bytes received in the state information whenever the data of the small section is received (Step S934 of FIG. 9). When it is determined that a sufficient number of bytes to be played is received, the control unit 103 instructs the playing unit 107 to perform playing (Step S1001 of FIG. 10). In this way, the playing unit 107 starts the playing of a small section D₁₁ (Step S1003 of FIG. 10). Then, the control unit 103 updates the corresponding entry to “being played” in the state information (this process is not shown in FIG. 10).

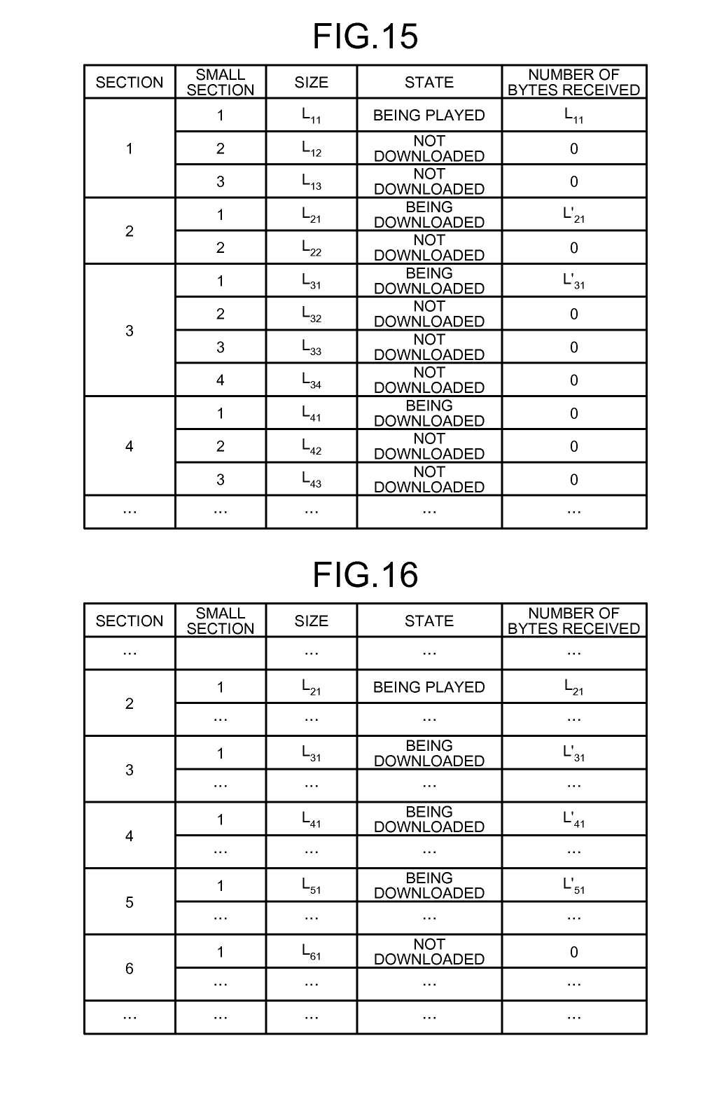

Then, when the download of the small section D₁₁ ends, the communication unit 102 starts the reception (download) of the data of the first small section in the next section under the control of the download control unit 112 (Steps S1010 to S1013). As a result, the state information is updated as shown in FIG. 15. That is, the entry of the first small section in chapter 4 is updated to “being downloaded”.

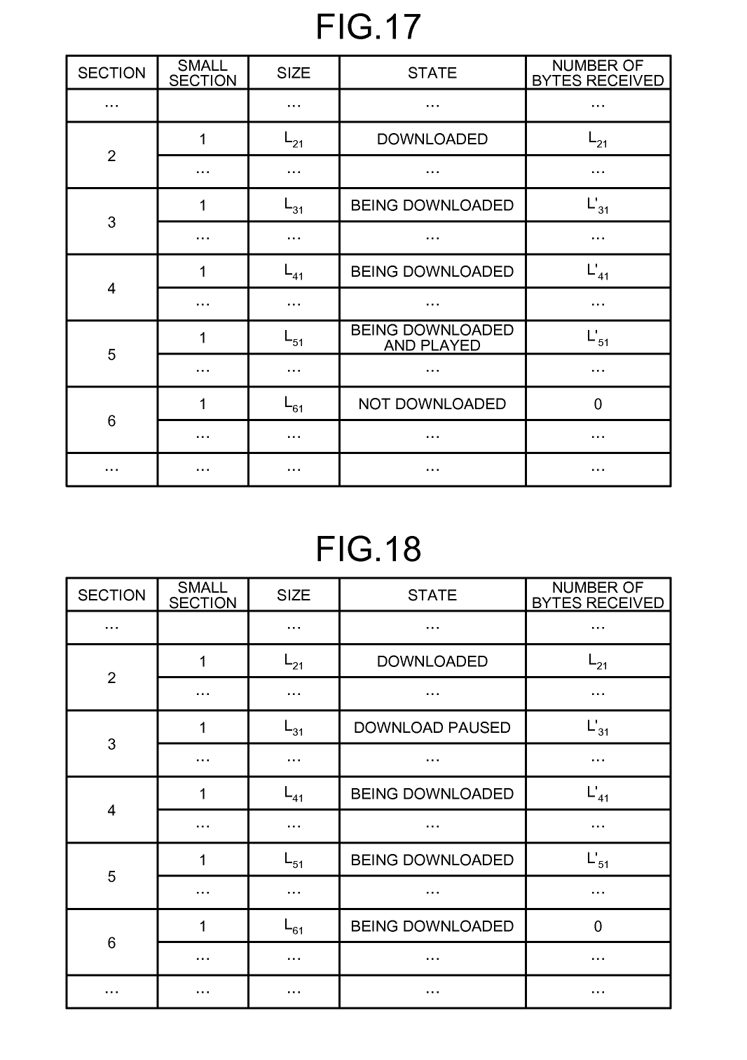

In the communication device 100, when the user interface unit 106 receives an operation to move to another chapter (section) and the amount of downloaded data of the first small section in the section is sufficient to be played, the control unit 103 updates an entry corresponding to the small section indicating a movement destination to “being played” in the state information. For example, when movement to data D51 of the small section is instructed and the amount of downloaded data D51 of the small section is sufficient to be played, the control unit 103 updates the first small section of chapter 2 and the first small section of chapter 5 from the state information shown in FIG. 16 to the state information shown in FIG. 17.

When the amount of downloaded data Dₓ₁ of the small section in the section, which is a movement destination, is insufficient to be played (Step S810: No in FIG. 8), the data Dₓ₁ of the small section is not downloaded, and the download counter n is equal to or more than the maximum number N of downloads (Step S816: No), the control unit 103 cancels the download of the data of an appropriate small section among the small sections which are represented by the entry “being played” in the state information (Step S817) and subtracts “1” from the download counter n (Step S818). Then, the communication unit 102 newly starts the download of the data Dₓ₁ of the small section under the control of the download control unit 112 (Step S819).

FIG. 16 shows an example of the above-mentioned process in which, while a small section D21 is being played, chapters 3 to 5 are being downloaded. When a small section D51 is selected as a movement destination, the control unit 103 updates the entry of the small section D21 to “downloaded” and updates the entry of the small section D51 to “being download and played”, as in the state information shown in FIG. 17.

In the situation shown in FIG. 16, when a small section D61 is selected as a movement destination, the download of a small section D31 is cancelled and the download of the small section D61 starts. As in the state information shown in FIG. 18, the control unit 103 updates the entry of the small section D21 to “downloaded”, updates the entry of the small section D61 to “being downloaded”, and updates the entry of the small section D31 to “download paused”.

In the first embodiment described above, when downloading a plurality of small sections in parallel, the communication device 100 may control the download speed of each small section. For example, the following control methods are considered: a method of preferentially downloading the section which is being played; a method of giving priority to the first small section in each section; and a method of allocating a band in order of the distance from a playing position.

In the communication device 100 according to the first embodiment, it is important to download the data of the first small section in each chapter (section) early. Therefore, at the beginning, low-quality content may be downloaded to reduce the amount of download data and the download time. In this case, the following two methods are considered: a method in which a plurality of content files with different qualities is prepared in the content management server 201; and a method of preparing content that is encoded by a scalable coding method. In both the two methods, since low-quality content is downloaded in advance, it is possible to reduce capacity and time. When the communication device 100 performs playing, content is replaced with the downloaded content or the downloaded content is added to content. In this way, the communication device 100 plays high-quality content.

### MODIFICATIONS OF FIRST EMBODIMENT

In the first embodiment, the start time or the number of start bytes is included in each of the chapters dividing the content of the meta information. However, the embodiment is not limited to the meta information in which the start time or the number of start bytes is included in each chapter (section). Instead of including the separation position of data, the meta information may include only information indicating the internal structure of content.

In this case, a download control unit 112 according to this modification may separate content, specify the separation position, and perform download control according to the specified separation position, on the basis of the analysis result of the meta information. A download method is the same as that in the first embodiment and thus a description thereof will not be repeated.

Various methods other than the above-mentioned methods are considered. For example, as the method of specifying the separation position of content, the following method may be used in which information related to the structure of the previously played content is stored in the communication device 100 and the communication device 100 uses the content when the content is played again.

### Second Embodiment

In the communication device 100 according to the first embodiment, the small sections of each chapter to be downloaded are sequentially selected from chapter 1. However, the invention is not limited to the selection method. In a second embodiment, an example in which the communication device 100 determines the order of chapters to be downloaded will be described.

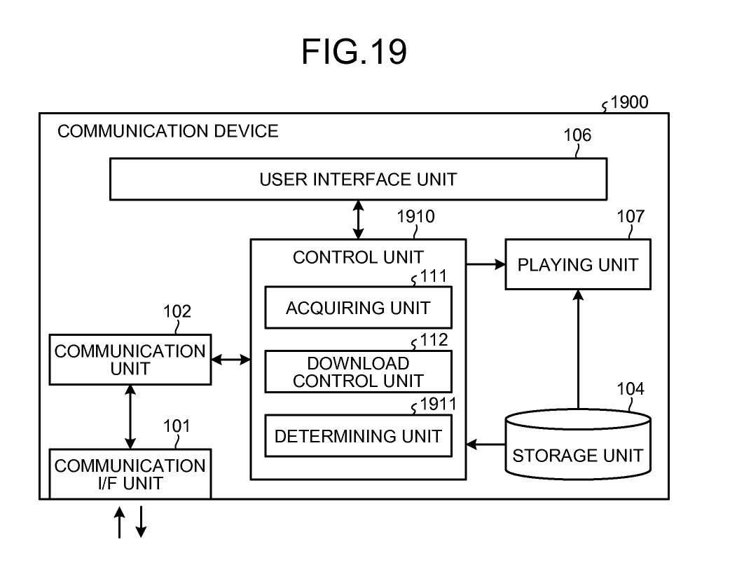

FIG. 19 is a block diagram illustrating the structure of a communication device 1900 according to the second embodiment. As shown in FIG. 19, the communication device 1900 is different from the communication device 100 according to the first embodiment in that a control unit 1910 replaces the control unit 103. In the second embodiment, the same components as those in the first embodiment are denoted by the same reference numerals and a description thereof will not be repeated.

The control unit 1910 is different from the control unit 103 according to the first embodiment in that it further includes a determining unit 1911.

The determining unit 1911 determines the order in which the download control unit 112 downloads a plurality of chapters (sections) constituting content.

In this embodiment, the control unit 103 analyzes meta information and the determining unit 1911 determines the download order of the sections according to the priority of each of the extracted sections.

A technique has been proposed in which the user sets sections in content and shares the content with other users through a network, in order to view a desired scene. In addition, a technique has been proposed in which the number of times the scene is viewed or popularity for each divided section set by the user is stored. In the meta information management server 202 according to this embodiment, the priority of each section is set to the meta information provided to the communication device 1900 on the basis of the sections set by other users, the number of times the scene is viewed, or popularity. The section with higher priority has a higher reputation from the other users. Therefore, the user who views the content with the communication device 1900 is likely to be interested in the section and is likely to preferentially view the section.

The determining unit 1911 according to this embodiment determines the download order of each section in the content according to the sections set by the user and priority based on the popularity of each section included in the meta information.

Then, the download control unit 112 downloads the data of three small sections in parallel in the download order determined by the determining unit 1911, similarly to the first embodiment.

As such, in this embodiment, the communication device 1900 downloads the data of the small sections in the order determined by the determining unit 1911. In this way, it is possible to preferentially download the data of the small section that is likely to be viewed by the user. Therefore, it is possible to improve the possibility of content being seamlessly played when the content is moved.

### Third Embodiment

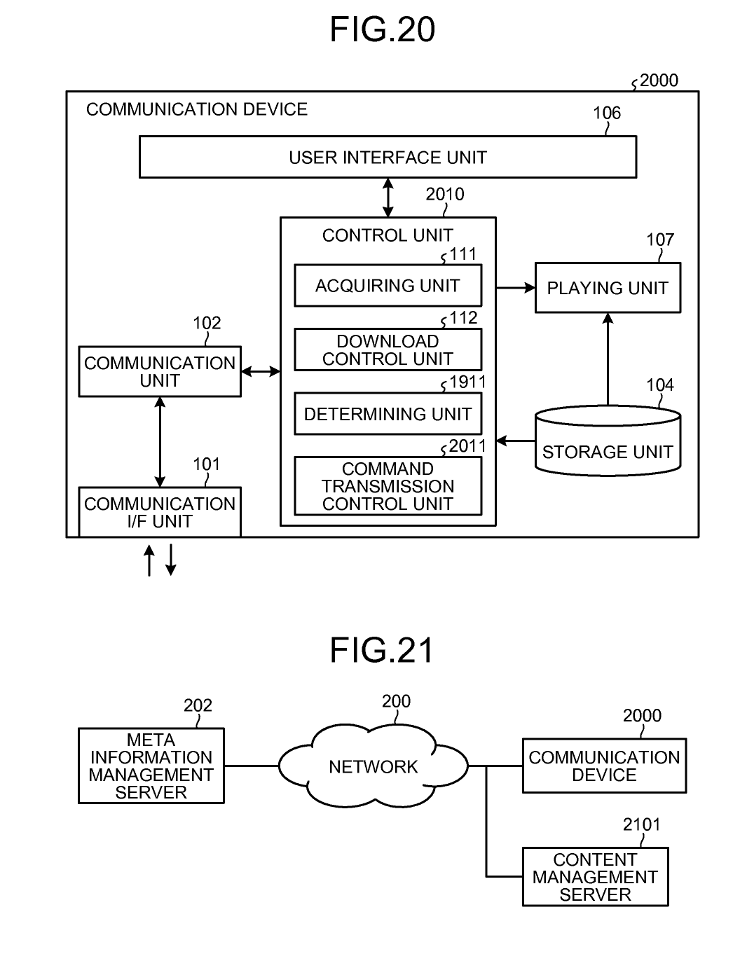

Next, a third embodiment will be described. FIG. 20 is a block diagram illustrating the structure of a communication device 2000 according to a third embodiment. As shown in FIG. 20, the communication device 2000 is different from the communication device 100 according to the first embodiment in that a control unit 2010 replaces the control unit 1910. In the third embodiment, the same components as those in the second embodiment are denoted by the same reference numerals and a description thereof will not be repeated.

The control unit 2010 is different from the control unit 1910 according to the second embodiment in that it further includes a command transmission control unit 2011.

The command transmission control unit 2011 generates a resuming command or a suspension command for a content management server 2101 shown in FIG. 21 and controls the communication unit 102 such that the transmission of the resuming command or the suspension command is controlled.

FIG. 21 is a diagram schematically illustrating a network according to the third embodiment. As shown in FIG. 21, the communication device 2000 and the content management server 2101 are connected to each other by a small-scale network, such as a home LAN or an office LAN. In this network configuration, it is not preferable to operate the content management server 2101 all the time in terms of power consumption.

The content management server 2101 according to this embodiment can perform switching between a non-operating state and an operating state. The content management server 2101 can change the state between at least two states, that is, the operating state and the non-operating state in response to a control instruction from the communication device 2000.

As such, the command transmission control unit 2011 has a function of outputting an instruction to control the state of the content management server 2101 according to the content download condition of the communication device 2000. In this case, the command transmission control unit 2011 has a function of generating a control command to change the operation state of the communication device to the operating state or the non-operating state and transmitting the control command to the content management server 2101 through the communication unit 102.

The command transmission control unit 2011 uses a control method suitable for the content management server 2101. The content of the control operation of the command transmission control unit 2011 depends on the performance of the content management server 2101. For example, the command transmission control unit 2011 has a function of generating a resuming command for the content management server 2101 such that the content management server 2101 receives an instruction from the outside and returns from the “non-operating state” (a state in which the content management server cannot respond to an inquiry from the outside) to the “operating state” (a state in which the content management server can rapidly provide content).

For example, in the case where the content management server 2101 can return with a Wake-on-LAN using Magic Packet (registered trademark), the command transmission control unit 2011 has a function of generating Magic Packet and a function of transmitting Magic Packet through the communication unit 102. In addition, resuming instruction methods using a wireless medium, such as infrared rays or radio waves, and various kinds of wired media including a power line are considered. In these methods, when a communication interface different from that in general communication is needed, the communication device 2000 needs to include another communication interface corresponding to the resuming instruction function, in addition to the communication I/F unit 101.

When the communication device 2000 includes neither the unit corresponding to a change “non-operating state→operating state” nor the unit corresponding to a change “operating state→non-operating state”, the command transmission control unit 2011 according to this embodiment may be configured not to perform an operation corresponding to one of the units. Alternatively, the command transmission control unit 2011 may be configured to request another communication device including the corresponding unit to perform its process.

The command transmission control unit 2011 generates a command to instruct the content management server 2101 to suspend the process, if necessary. For example, it is assumed that the content management server 2101 can download content using an HTTP. The content management server 2101 can receive an instruction to change to the non-operating state as an HTTP message. In this case, the command transmission control unit 2011 has a function of generating an HTTP message for suspension instruction and transmitting the HTTP message through the communication unit 102.

When the content management server 2101 can change to various states other than the “operating state” and the “non-operating state”, the command transmission control unit 2011 may have a control instruction method for changing to these states.

Whether the command transmission control unit 2011 directly transmits a control instruction to the communication I/F unit 101 or requests the communication unit 102 to transmit the control instruction depends on the control method and structure used.

When the content management server 2101 has such a state control function, the meta information transmitted to the communication device 2000 may be different from that in the first embodiment. For example, the meta information has the same format as that in the first embodiment, but the small section may be determined on the basis of a change in the state of the server. That is, as the minimum data size of each section, the data length of each small section may be determined so as to ensure the shortest playing time at which the content management server 2101 changes the state in the order of “operation state→non-operating state→operation state” to reduce energy consumption. In addition, the data size of the small section may be determined on the basis of the bandwidth of a communication path between the content management server 2101 and the communication device 2000 or a bandwidth delay product.

As such, in this embodiment, the content management server 2101 transmits server information including the period of time required to change the state from the operating state to the non-operating state and the period of time required to change the state from the non-operating state to the operating state to the communication device 2000 so that the communication device 2000 recognizes the period of time required to change the state.

The server information includes, for example, a change methods (for example, a suspension instruction method and a resuming instruction method) between the states (for example, the operating state and the non-operating state) supported by the content management server 2101 or the period of time required for the change between the states. The communication device 2000 may analyze the server information to determine whether the command transmission control unit 2011 corresponds to instructions. The server information is also used by the command transmission control unit 2011 to control command transmission timing.

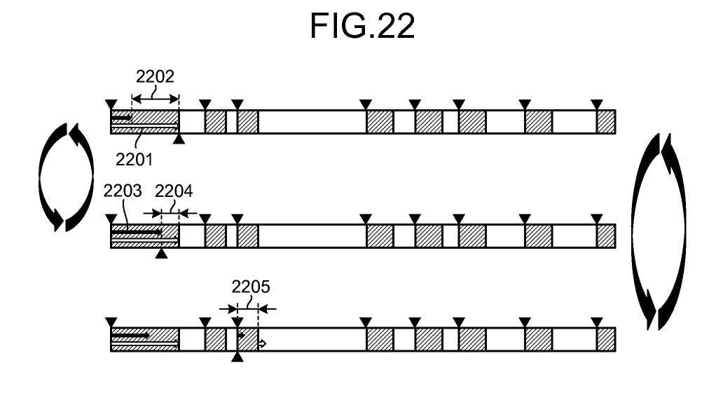

FIG. 22 is a diagram illustrating the change timing of the state of the content management server 2101 between the operating state and the non-operating state depending on the download conditions of content. In the example shown in FIG. 22, it is assumed that data 2201 has been downloaded. In this case, there is data 2202 that has not been played. The switching between the states of the content management server 2101 is controlled on the basis of the size of the data 2202 that has not been played. It is assumed that, before the switching control operation, the communication device 2000 receives the server information from the content management server 2101 and recognizes the period of time required to change the state.

In addition, the control unit 2010 of the communication device 2000 specifies a data size required to seamlessly play content for the period of time required for the content management server 2101 to change the state (for example, the operating state→the non-operating state→the operating state), on the basis of a network speed between the communication device 2000 and the content management server 2101 and the bit rate of the content.

As shown in FIG. 22, it is assumed that the communication device 2000 has downloaded the data size 2201 and the data size 2202 has not been played in chapter 1 of the content.

When the control unit 2010 determines that the data size of the data 2202 which has not been played is more than a data size necessary for seamless playing for the period of time required to change the state (for example, the operating state→the non-operating state→the operating state), the command transmission control unit 2011 generates a command to change the state to the non-operating state and controls the transmission of the command to the content management server 2101 through the communication unit 102.

After the playing 2203 of the content, at a predetermined timing at which the data size 2204 which has not been played does not become less than the data size necessary for seamless playing for the period of time required to change the state (for example, the non-operating state→the operating state), the command transmission control unit 2011 generates a command to change the state to the operating state and controls the transmission of the command to the content management server 2101 through the communication unit 102.

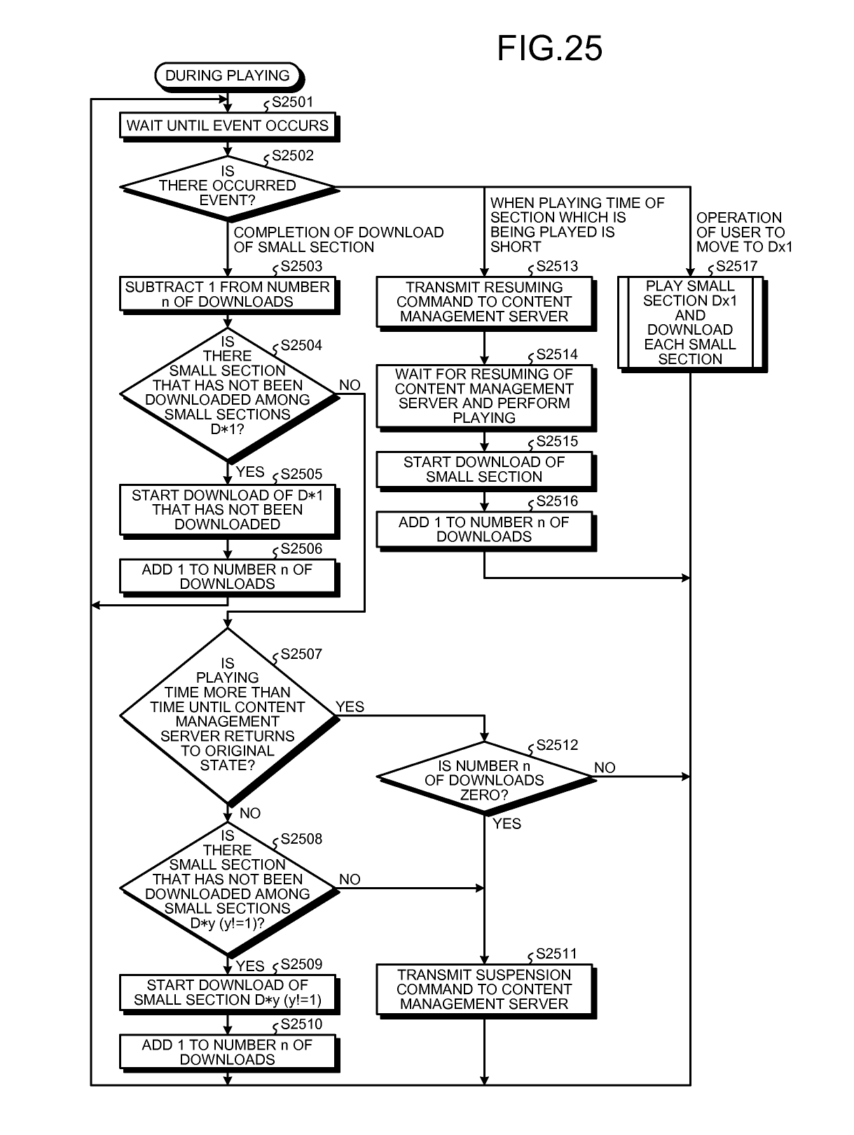

The control unit 2010 performs the determination on the basis of the data size, but the embodiment is not limited thereto. The control unit 2010 performs the determination on the basis of the playing time. An example in which the playing time is used instead of the data size will be described later with reference to FIG. 25. As such, any of the data size and the playing time may be used as long as it is capable of determining whether content is seamlessly played.

Even when the user interface unit 106 receives an operation to move to another chapter, the command transmission control unit 2011 generates a command to change the state on the basis of the data size 2205 which has not been played in the chapter, which is a movement destination, and controls the transmission of the command to the content management server 2101 through the communication unit 102. The command generation conditions are the same as those described above and thus a description thereof will not be repeated. The command transmission control unit 2011 may have enough time, e.g., 5 seconds or 10 seconds, to generate and transmit the command.

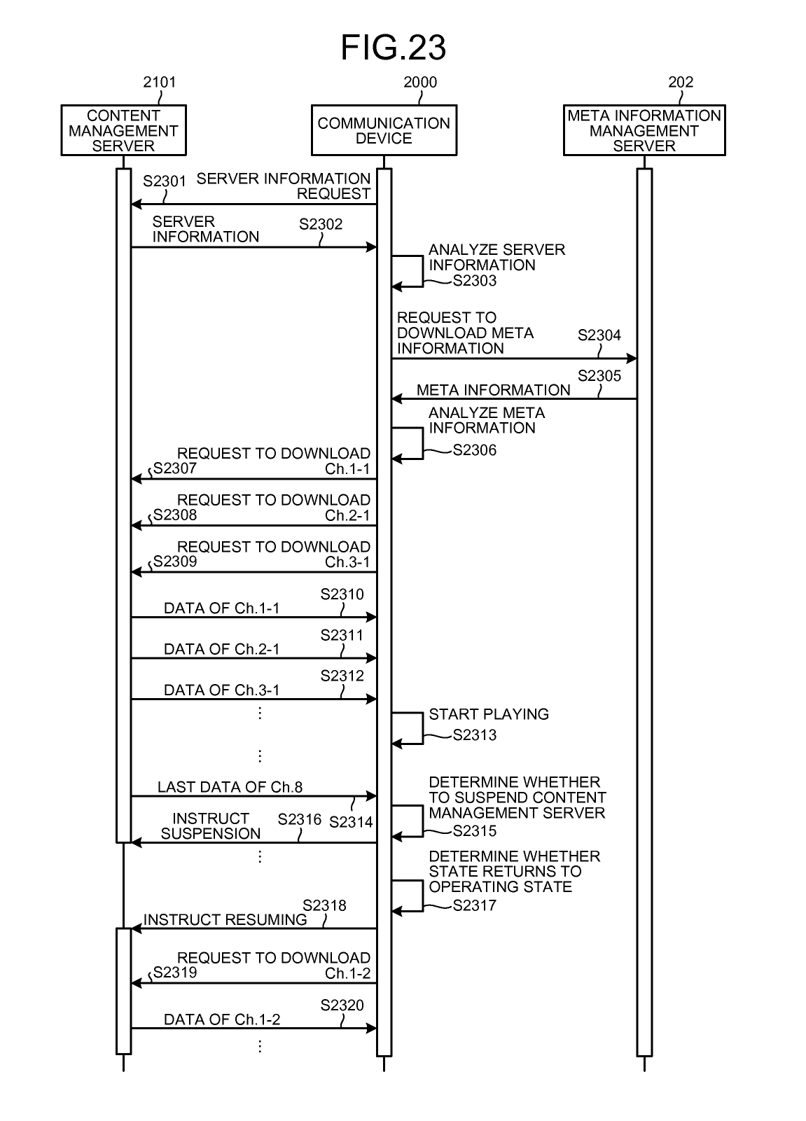

FIG. 23 is a sequence diagram illustrating an operation between the communication device 2000 and the content management server 2101 according to this embodiment. In the sequence shown in FIG. 23, first, the communication unit 102 of the communication device 2000 transmits a server information transmission request to the content management server 2101 under the control of the control unit 2010 (Step S2301). Then, the content management server 2101 transmits server information to the communication device 2000 (Step S2302). The server information is stored in the storage unit 104.

The control unit 2010 of the communication device 2000 analyzes the server information stored in the storage unit 104 (Step S2303). In this way, the control unit 2010 can recognize a command to change the state of the content management server 2101 to the operating state, a command to change the state of the content management server 2101 to the non-operating state, and the period of time required to change the state of the content management server 2101.

Then, the same steps as those (Steps S601 to S610) in the first embodiment shown in FIG. 6 are performed before the start of playing (Steps S2304 to S2313).

Then, the communication unit 102 of the communication device 2000 receives the last data of the first small section in chapter 8 (Ch.8) (Step S2314). Then, the control unit 2010 determines whether to suspend the content management server 2101 (Step S2315). The determination method is the same as described above and a description thereof will not be repeated.

When the control unit 2010 determines to suspend the content management server 2101, the command transmission control unit 2011 generates a suspension command to change the state to the non-operating state and transmits the suspension command to the content management server 2101 through the communication unit 102 (Step S2316).

Then, the control unit 2010 determines whether to resume the content management server 2101 to the operating state (Step S2317). The determination rule is the same as described above and a description thereof will not be repeated. Next, a case in which the content management server 2101 needs to return to the operating state will be described.

First, the command transmission control unit 2011 generates a resuming command to change the state to the operating state and transmits the resuming command to the content management server 2101 (Step S2318). Then, the content management server 2101 changes to the operating state.

Then, the communication device 2000 waits until the content management server 2101 changes to the operating state. The waiting time is determined on the basis of the server information. Then, the download control unit 112 controls the communication unit 102 such that a request to download the second small section (Ch.1-2) of chapter 1 is transmitted to the content management server 2101 (Step S2319). Then, the download control unit 112 controls the communication unit 102 such that the data of the second small section of chapter 1 is downloaded from the content management server 2101 (Step S2320).

As such, the communication device 2000 according to this embodiment transmits the suspension command at the time when it is determined that the download of content from the content management server 2101 is not needed and transmits the resuming command at the time when it is determined that the download of content from the content management server 2101 is needed. In this way, it is possible to prevent the content management server 2101 from being unnecessarily in the non-operating state.

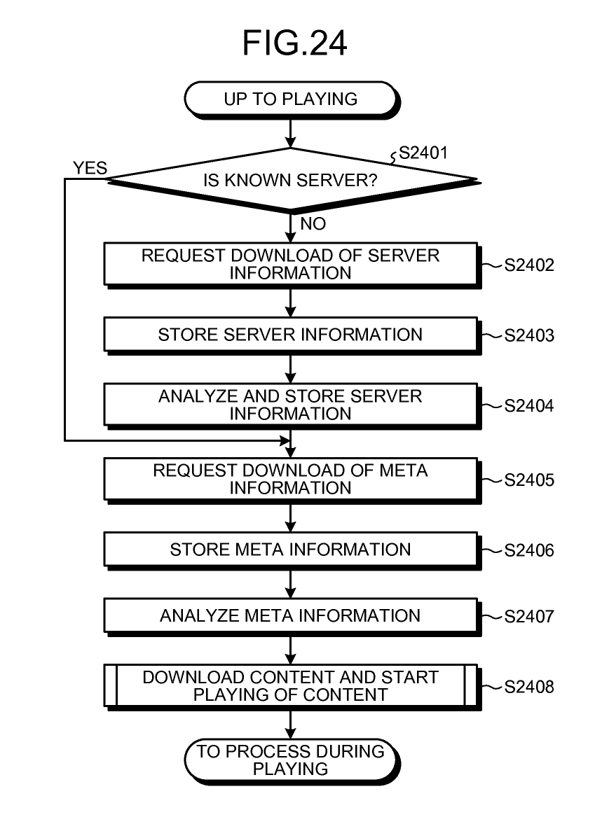

Next, the process of the communication device 2000 according to this embodiment up to the start of playing will be described. FIG. 24 is a flowchart illustrating the process of the communication device 2000 up to the start of playing. In this embodiment, the communication unit 102 needs to request the transmission of the server information in advance under the control of the control unit 2010, but does not need to reacquire the server information of the server which has already been acquired. The control unit 2010 determines whether there is a server whose server information has been acquired (Step S2401). When it is determined that there is a server whose server information has been acquired (Step S2401: Yes), processes at Step S2405 and thereafter are performed. This determination step is not indispensible, but it may be performed every time.

On the other hand, when the control unit 2010 determines that the server information needs to be acquired (Step S2401: No), the control unit 2010 generates a server information acquisition request and transmits the server information acquisition request to the content management server 2101 (Step S2402). Then, the communication unit 102 receives the server information from the content management server 2101, which is the destination of the acquisition request, and stores the server information in the storage unit 104 (Step S2403). Then, the control unit 2010 analyzes and stores the acquired server information (S2404).

The subsequent steps are the same as those (Steps S701 to S713) in the first embodiment. That is, the meta information and content are downloaded and the playing of the content starts (Steps S2405 to S2408).

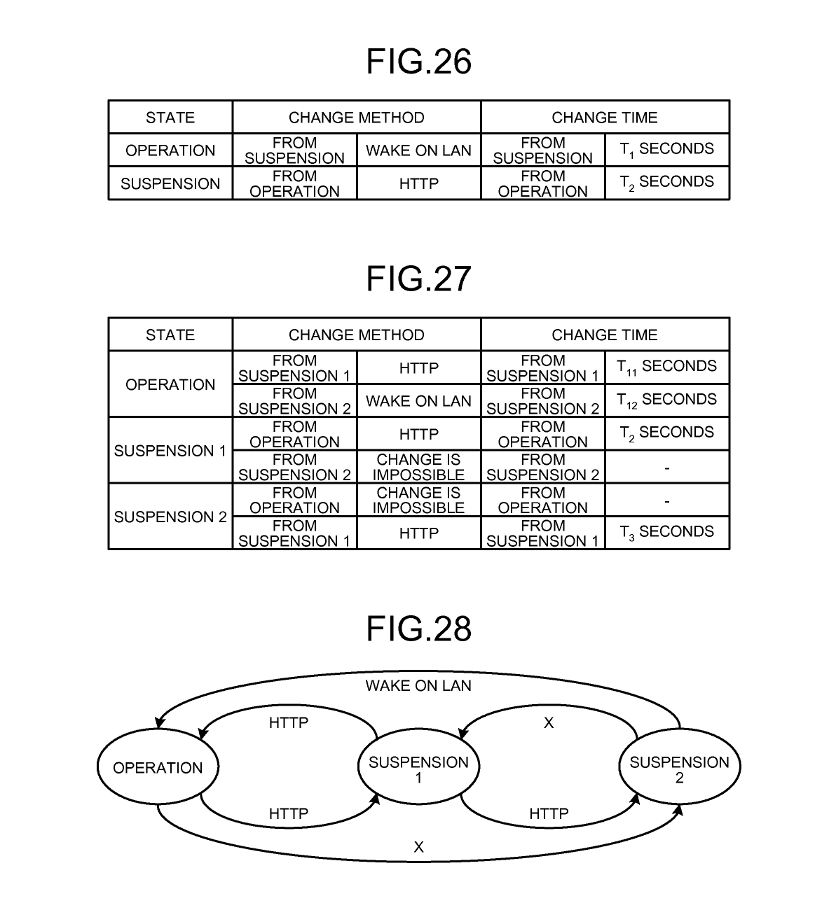

The analysis result of the server information by the control unit 2010 in Step S2404 of FIG. 24 will be described. FIG. 26 is a diagram illustrating a first example of the information stored in the storage unit 104 as the analysis result of the server information by the control unit 2010. In the example shown in FIG. 26, the content management server 2101 includes two states “operation” and “suspension”. A method for a change between the states and the period of time required for a change between the states are stored so as to be associated with each other for each state.

FIG. 27 is a diagram illustrating a second example of the information stored in the storage unit 104 as the analysis result of the server information by the control unit 2010. In the example shown in FIG. 27, there are three kinds of states “operation”, “suspension 1”, and “suspension 2”. Similarly to FIG. 26, a method for a change between the states and the period of time required for a change between the states are stored so as to be associated with each other for each state. It is assumed that, when it is difficult to make a change between two states, “change is impossible” is set as the change method.

FIG. 28 is a diagram illustrating a change in each state according to the server information shown in FIG. 27. As shown in FIG. 28, in the operating state and suspension 1, it is possible to change the state with an HTTP command. In contrast, in suspension 2, since the communication device cannot recognize the HTTP command, it starts by the Wake-on LAN.

The server information may have any format. For example, the server information may have an XML format.

Next, the process of the communication device 2000 according to this embodiment during playing will be described. FIG. 25 is a flowchart illustrating the process of the communication device 2000 during playing. First, similarly to Steps S801 to S806 of FIG. 8, the download of the data D_{*1} of the small section which has not been downloaded starts (Steps S2501 to S2506). However, this process is different from that shown in FIG. 8 in that a case in which the time when the downloaded small section in the section which is being played can be played become less than a threshold value is added as a trigger event and a process corresponding to the occurrence of the event is added to Steps S2513 to S2516. This event is for resuming the content management server 2101 in the non-operating state to the operating state. A process when this event occurs will be described later.

Then, in Step S2504, when the control unit 2010 determines that there is no data D_{*1} of the small section which has not been downloaded (Step S2504: No), it compares the period of time (hereinafter, the playing time) when a portion which has not been played in the downloaded small section of the section which is being played can be played with the period of time required for the content management server 2101 to return to the original state through a state change operation (the sum of the period of time required for a change to the non-operating state and the period of time required for returning to the operating state) (Step S2507). In addition, another parameter, such as the minimum duration to get benefit from the reduced power consumption based on the state transition more than its overhead, may be added as the time required to return to the operating state.

When it is determined that the playing time is more than the time required for the content management server 2101 to return to the original state (Step S2507: Yes), the control unit 2010 determines whether the current download counter n is “0” (Step S2512). When the control unit 2010 determines that the current download counter n is not “0” (Step S2512: No), it waits until an event occurs (Step S2501). On the other hand, when the control unit 2010 determines that the current download counter n is “0” (Step S2512: Yes), the command transmission control unit 2011 generates a suspension command to change the state of the content management server 2101 to the non-operating state and transmits the suspension command to the content management server 2101 (Step S2511). The determination process based on the download counter n in Step S2512 is performed by the control unit 2010 with reference to the counter value stored in the storage unit 104. In addition, the suspension command is transmitted in the same way as described above. The suspension command is transmitted on the basis of the settings read from the server information.

When it is determined in Step S2507 that the playing time is less than the time required for the content management server 2101 to return to the original state (Step S2507: No), the control unit 2010 determines whether there is the data D_{*y} (y!=1) of the small section which has not been downloaded (Step S2508).

When the control unit 2010 determines that there is no data D_{*y} (y!=1) of the small section which has not been downloaded (Step S2508: No), the command transmission control unit 2011 generates a suspension command and transmits the suspension command to the content management server 2101 since the download of the data D_{*y} (y!=1) of all small sections has been completed (Step S2511).

When it is determined in Step S2508 that there is the data D_{*y} (y!=1) of the small section which has not been downloaded (Step S2508: Yes), the download of the data D_{*y} (y!=1) of the small section starts and “1” is added to the download counter n, similarly to the first embodiment (Steps S808 and S809 of FIG. 8) (Steps S2509 and Step S2510).

The playing time which is a basis of occurrence of an even in Step S2501 is calculated on the basis of the meta information, as described above. That is, the relation between the data size of the downloaded content and the playing time is calculated on the basis of the time information of each section included in the meta information. For example, when content is encoded by CBR, the playing time of a section may be divided by the number of bytes of the section to calculate the playing time per byte. When content is encoded by VBR, the average bit rate of each small section may be used to calculate the playing time per byte, similarly to the CBR system. Alternatively, the playing time per byte may be calculated using information obtained by playing content. The information of the playing time calculated by any of the above-mentioned methods is compared with the period of time required to change the state.

In Step S2502, when the control unit 2010 determines that an event “when the playing time of the section which is being played is short” occurs (Step S2502), the command transmission control unit 2011 of the communication device 2000 controls the communication unit 102 such that a resuming command to change to the operating state is directly transmitted to the content management server 2101 (Step S2513). The resuming command is generated on the basis of the server information.

Then, the control unit 2010 waits for the return of the content management server 2101 to the operating state on the basis of the server information, and the playing unit 107 continuously plays the content (Step S2514). When the waiting state ends, the download control unit 112 requests the content management server 2101 to download the data of the small section. Then, the download control unit 112 starts to download the data of the small section from the content management server 2101 (Step S2515). It is assumed that the data of the small section which is played earliest among the small sections which have not been downloaded and are needed to continuously perform the current playing is requested. The control unit 2010 adds “1” to the download counter n (Step S2516).

In this embodiment, in the case where both the content management server 2101 and the communication device 2000 can stop and resume the download of content at any position, such functions of the content management server 2101 and the communication device 2000 may be used to change the state of the content management server 2101 to the non-operating state at any timing. That is, instead of the process of determining whether the download counter n shown in FIG. 25 is “0”, the download of the entire content during communication may be stopped and the content management server 2101 may be instructed to change to the non-operating state.

In Step S2502, when the control unit 2010 determines that the event “operation of the user to move to Dₓ₁” occurres (Step S2502), the data Dₓ₁ of the small section is played and each small section is downloaded, similarly to Steps S810 to S823 according to the first embodiment shown in FIG. 8 (Step S2517).

As such, in the third embodiment, since the content management server 2101 that provides content is changed to the non-operating state, it is possible to reduce the power consumption of the entire system, in addition to the effect of the first embodiment. Since data is downloaded for each small section by the method described in the first embodiment, it is possible to hide the period of time required to change the state of the content management server 2101.

In the above-described embodiments and modifications, when content is downloaded, the first small section in each of the sections dividing the content is downloaded. Therefore, even when an operation to move the section is selected during the playing of the content, it is possible to play the content from the position of a movement destination, without stopping the playing. In this way, it is possible to improve user convenience.

The communication device according to each of the embodiments described above includes a control device, such as a CPU, a storage device, such as a read only memory (ROM) or a RAM, an external storage device, such as an HDD or a CD drive, a display device, and an input device, such as a keyboard or a mouse, and has a hardware structure using a general computer.

A communication control program executed by the communication device according to each of the embodiments described above is recorded as a file of an installable format or an executable format on a computer-readable recording medium, such as a CD-ROM, a flexible disk (FD), a CD-R, or a digital versatile disk (DVD) and then provided.

The communication control program executed by the communication device according to each of the embodiments described above may be stored in a computer that is connected to a network, such as the Internet, may be downloaded through the network, and then provided. In addition, the communication control program executed by the communication device according to the above-described embodiments may be provided or distributed through a network, such as the Internet.

The communication control program executed in this embodiment may be incorporated into, for example, a ROM in advance and then provided.

The communication control program executed by the communication device according to each of the above-described embodiments has a module structure including each of the above-mentioned units (the communication unit, the control unit, and the playing unit). As the actual hardware, a CPU reads the communication control program from the recording medium and executes the communication control program. Then, each of the above-mentioned units is loaded to the main storage device, and the communication unit, the control unit, and the playing unit are generated on the main storage device.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirits of the inventions.

What is claimed is:

1. A data processing apparatus comprising:
an acquiring unit configured to acquire structural information indicating a structure of data;
a download control unit configured to download one or more partial data pieces among a plurality of partial data pieces obtained by separating the data on the basis of the structural information, using a separation position of the data as a download start position;
a selection receiving unit configured to receive a selection of the separation position of the data; and
an output unit configured to output the data from the selected separation position received by the selection receiving unit.

2. The apparatus according to claim 1, further comprising:
a determining unit configured to determine an order in which the plurality of partial data pieces is downloaded,
wherein the download control unit downloads the one or more partial data pieces in the order determined by the determining unit.

3. The apparatus according to claim 1,
wherein, when the output unit starts the output of the partial data pieces and the download control unit resumes the download of the partial data pieces,
the download control unit
stops the download of the partial data pieces after a data size of downloaded partial data pieces becomes sufficient to be seamlessly output by the output unit, and
downloads another partial data piece using another separation position as the download start position.

4. The apparatus according to claim 3, further comprising:
a transmission control unit configured to transmit, in a case where a data storage device, which is a download destination of the download control unit, can change between a operating state in which the data storage device can transmit data and a non-operating state in which the data storage device cannot transmit data, a request to change to the non-operating state and a request to change to the operating state to the data storage device.

5. The apparatus according to claim 4,
wherein the transmission control unit transmits the request to change to the non-operating state to the data storage device when a data size of partial data piece which has not been output by the output unit among the partial data pieces which have been downloaded by the download control unit is equal to or more than a data size of partial data pieces to be able to be seamlessly output from the output unit for a period of time required for the data storage device to sequentially change to the operating state, the non-operating state, and the operating state.

6. The apparatus according to claim 4,
wherein the transmission control unit transmits the request to change to the operating state to the data storage device at a predetermining timing at which the data size of the partial data piece which has not been output by the output unit among the partial data pieces which have been downloaded by the download control unit does not become less than a data size to be able to be seamlessly output for a period of time required for the data storage device to change from the non-operating state to the operating state.

7. The apparatus according to claim 1,
wherein the structural information acquired by the acquiring unit includes the separation position of the data as the structure of the data.

8. The apparatus according to claim 1,
wherein the structural information acquired by the acquiring unit does not include the separation position of the data as the structure of the data, and
the download control unit analyzes the structure of the data in the structural information, specifies the separation position, and then downloads the partial data pieces.

9. A data processing method performed in a data processing device, the method comprising:
allowing an acquiring unit of the data processing device to acquire structural information indicating a structure of data;
allowing a download control unit of the data processing device to download one or more partial data pieces among a plurality of partial data pieces obtained by separating the data on the basis of the structural information, using a separation position of the data as a download start position;
allowing a selection receiving unit of the data processing device to receive a selection of the separation position of the data; and
allowing an output unit of the data processing device to output the data from the selected separation position received by the selection receiving unit.

10. A computer program product comprising a computer readable medium including programmed instructions, wherein the instructions, when executed by a computer, cause the computer to perform:
acquiring structural information indicating a structure of data;
downloading one or more partial data pieces among a plurality of partial data pieces obtained by separating the data on the basis of the structural information, using a separation position as a download start position;
receiving a selection of the separation position of the data; and
outputting the data from the selected separation position received in the receiving.
